(19) United States
(12) Patent Application Publication
(10) Pub. No.: US 2025/0086031 A1
(43) Pub. Date: Mar. 13, 2025

(54) COMPUTING APPARATUS AND METHOD FOR EXECUTING CONVOLUTION OPERATION, AND RELATED PRODUCTS

(71) Applicant: Cambricon (Xi'an) Semiconductor Co., Ltd., Xi'an (CN)

(72) Inventors: Yufeng GAO, Xi'an (CN); Jinhua TAO, Xi'an (CN)

(73) Assignee: Cambricon (Xi'an) Semiconductor Co., Ltd., Xi'an (CN)

(21) Appl. No.: 18/711,594

(22) PCT Filed: Jun. 20, 2022
(86) PCT No.: PCT/CN2022/099770

§ 371 Date: Dec. 2, 2024

(30) Foreign Application Priority Data
Nov. 19, 2021 (CN) 202111401514.4

(51) Int. Cl. G06F 9/54; G06F 12/0842

(52) U.S. Cl. CPC G06F 9/54; G06F 12/0842; G06F 2209/543; G06F 2212/62

(57) ABSTRACT

A computing apparatus, a method of performing a convolution operation utilizing the computing apparatus, and related products are described. The computing apparatus is included in a combined processing apparatus. The combined processing apparatus further includes an interface apparatus and other processing apparatus. The computing apparatus interacts with other processing apparatus to jointly complete a user specified computation operation. The combined processing apparatus further includes a storage apparatus. The storage apparatus is connected to the computing apparatus and other processing apparatus, respectively. The storage apparatus is used to store data of the computing apparatus and other processing apparatus. The described techniques optimize the convolution operation to improve data reuse efficiency, thereby improving computational processing efficiency.

### CROSS REFERENCE OF RELATED APPLICATIONS

The present application claims priority to Chinese Patent Application No. 202111401514.4 with the title of “COMPUTING APPARATUS AND METHOD FOR EXECUTING CONVOLUTION OPERATION, AND RELATED PRODUCTS” filed on Nov. 19, 2021.

### TECHNICAL FIELD

The present disclosure generally relates to a field of data processing. More specifically, the present disclosure relates to a computing apparatus, a method of performing a convolution operation utilizing the computing apparatus, a chip, and a board card.

### BACKGROUND

At present, Deep Learning has become an important branch of machine learning, and also vigorously contribute to the development of artificial intelligence (AI). Deep neural network (DNN), the core technology of deep learning, has been widely used in many industries.

Neural network is one of the most critical techniques in artificial intelligence and deep learning, among which Convolution Neural Network (CNN) is one of the most important network types. The most critical computation in a convolutional neural network is a convolution operation on a Conv (convolutional) layer. The function of the convolutional layer is to extract features from input data, and complex features may be extracted by performing the convolution on a plurality of layers to ensure that the network has sufficient expressive power and generalization ability. A neural network model contains a large number and various types of convolution operations, and the computational performance of the convolution operations greatly affects the computational performance of the entire neural network model. When the neural network model is applied to different domains, such as speech recognition, machine translation, image processing, and the like, their corresponding input feature maps and the size of each dimension of weights may vary. In order to take full advantage of the hardware of a deep learning processor, it is necessary to optimize different scales, and/or different types of convolution operations to improve the computational performance of executing the neural network model.

### SUMMARY

In order to solve at least one or more technical problems as mentioned above, the present disclosure proposes, in various aspects, a computing apparatus which, by collapsing the width dimension of an input feature map, may enable data of various dimensional sizes to be adapted to hardware of the convolution operation, so as to improve the computational efficiency of the convolution operation. The convolution operation of embodiments of the present disclosure may be an operation in various neural network models that may be applied to various fields, such as image processing, speech processing, text processing, and the like, where these processes may, for example, include, but are not limited to, identification and classification.

A first aspect of the present disclosure provides a computing apparatus, including a plurality of slave processing circuits, where each slave processing circuit includes a first caching circuit, a second caching circuit, and a plurality of computing circuits. The first caching circuit is used to cache a plurality of input feature lines on which a convolution operation is to be performed, where one of the input feature lines includes the data amount of Pci×Ws=M in an input feature map, where Pci is a slice granularity of a Ci dimension of an input channel, Ws is a folding multiplier of a W dimension of the width, and M is the data amount of data processed by hardware at one time; the second caching circuit is used to cache weight data on which the convolution operation is to be performed; and each of the computing circuits is used to perform, at each computation, an element-wise multiplication and accumulation on an input feature line selected from the first caching circuit and an extended weight line selected or generated from the second caching circuit, respectively, where one extended weight line consists of a convolutional kernel sliced on a Ci dimension according to Pci, or, alternatively, consists of a convolutional kernel aligned to a column of data blocks of Pci that is replicated and extended into Ws columns.

A second aspect of the present disclosure provides a chip including the computing apparatus described in the first aspect of the present disclosure.

A third aspect of the present disclosure provides a board card including the chip described in the second aspect of the present disclosure.

According to the computing apparatus, the chip, the board card, and the method of implementing the convolution operation by the computing apparatus as provided above, the scheme of the embodiment of the present disclosure applies different width dimension folding schemes for input feature maps of different dimensional sizes to adapt to the processing capability of a hardware computing apparatus, thereby fully utilizing the parallel processing capability of a plurality of slave processing circuits, and the computational efficiency of the convolution operation may be effectively improved. Further, weights may be reused based on the granularity that is less than one weight line, thereby reducing frequent data loading and improving computational efficiency. Other advantages and effects will become easier to understand later in conjunction with the detailed description of the attached drawings.

### BRIEF DESCRIPTION OF DRAWINGS

By reading the following detailed description with reference to accompanying drawings, the above-mentioned and other objects, features and technical effects of exemplary embodiments of the present disclosure will become easy to understand. In the accompanying drawings, several embodiments of the present disclosure are shown in an exemplary but not restrictive manner, and the same or corresponding reference numerals indicate the same or corresponding parts of the embodiments.

FIG. 1 illustrates a structural diagram of a board card according to an embodiment of the present disclosure.

FIG. 2 illustrates a structural diagram of a combined processing apparatus according to an embodiment of the present disclosure.

FIG. 3 illustrates a schematic diagram of an internal structure of a processor core of a single-core or multi-core computing apparatus according to an embodiment of the present disclosure.

FIG. 4 illustrates an example of an exemplary principle of the convolution operation that may apply an embodiment of the present disclosure.

FIG. 5 illustrates an exemplary structural block diagram of a computing apparatus according to an embodiment of the present disclosure.

FIG. 6a-FIG. 6c illustrate several examples of data width dimension folding according to embodiments of the present disclosure.

FIG. 7 schematically illustrates an exemplary method of storing input feature maps according to some embodiments of the present disclosure.

FIG. 8 illustrates a schematic diagram of a convolutional kernel storage method according to an embodiment of the present disclosure.

FIG. 9 illustrates an exemplary cycle schematic diagram for computing a single convolutional output point according to an embodiment of the present disclosure.

FIG. 10 illustrates a schematic diagram of an operation for reusing data of an input feature map on an H dimension according to some embodiments of the present disclosure.

FIG. 11 illustrates a schematic method of slicing an output feature map according to an embodiment of the present disclosure.

FIG. 12a-FIG. 12c illustrate schematic diagrams of an operating process of the convolution operation scheme according to embodiments of the present disclosure.

FIG. 13 illustrates a schematic diagram of the logic for writing and outputting an operation result according to an embodiment of the present disclosure.

### DETAILED DESCRIPTION

Technical solutions in embodiments of the present disclosure will be described clearly and completely hereinafter with reference to accompanied drawings in the embodiments of the present disclosure. Obviously, embodiments to be described are merely some rather than all embodiments of the present disclosure. All other embodiments obtained by those of ordinary skill in the art based on the embodiments of the present disclosure without creative efforts shall fall within the protection scope of the present disclosure.

It should be understood that terms such as “first”, “second”, “third”, and “fourth” as they may appear in the claims, the specification, and drawings are used for distinguishing different objects rather than describing a specific order. It should be understood that terms “including” and “comprising” used in the specification and the claims indicate the presence of a feature, an entity, a step, an operation, an element, and/or an assembly, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, singular forms “a”, “an”, and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once”, or “in response to a determination” or “in response to a case where something is detected” depending on the context.

### Exemplary Hardware Environment

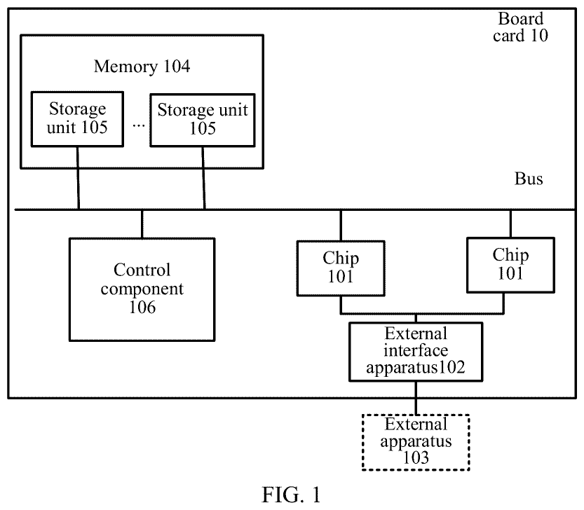

FIG. 1 is a structural diagram of a board card 10 according to an embodiment of the present disclosure. As shown in FIG. 1, the board card 10 includes a chip 101, which is an SoC (system-on-chip), or called an on-chip system. The chip 101 is integrated with one or more combined processing apparatuses. The combined processing apparatus is an artificial intelligence operation unit used to support various types of deep learning and machine learning algorithms to meet the intelligent processing requirements in complex scenarios in the fields of computer vision, speech, natural language processing, data mining, and the like. In particular, deep learning technology is widely applied in the field of cloud intelligence. A prominent feature of cloud intelligence application is the large amount of input data, which has high requirements on the storage capacity and computing power of a platform. The board card 10 of this embodiment is suitable for the cloud intelligence application. The board card 10 of this embodiment has huge off-chip storage, huge on-chip storage, and strong computing power.

The chip 101 is connected to an external apparatus 103 through an external interface apparatus 102. The external apparatus 103 may be, for example, a server, a computer, a camera, a monitor, a mouse, a keyboard, a network card, or a WIFI interface. To-be-processed data may be transferred from the external apparatus 103 to the chip 101 through the external interface apparatus 102. A computation result of the chip 101 may also be transferred by the external interface apparatus 102 back to the external apparatus 103. According to different application scenarios, the external interface apparatus 102 may have different interface forms, such as a PCIe (peripheral component interconnect express) interface.

The board card 10 further includes a memory 104 used for storing data, which includes one or a plurality of storage units 105. The memory 104 may connect to and transfer data to a control component 106 and the chip 101 through a bus. The control component 106 in the board card 10 may be configured to regulate and control a state of the chip 101. As such, in an application in scenario, the control component 106 may include an MCU (micro controller unit).

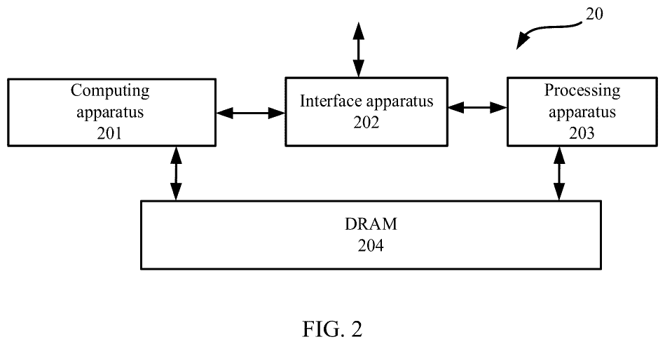

FIG. 2 is a structural diagram of a combined processing apparatus in a chip 101 according to an embodiment of the present disclosure. As shown in FIG. 2, a combined processing apparatus 20 includes a computing apparatus 201, an interface apparatus 202, a processing apparatus 203, and a storage apparatus 204.

The computing apparatus 201 is configured to perform an operation specified by a user. The computing apparatus 201 is mainly implemented as a single-core intelligent processor or a multi-core intelligent processor. The computing apparatus 201 is used for performing deep learning computing or machine learning computing. The computing apparatus 201 interacts with the processing apparatus 203 through the interface apparatus 202 to jointly complete the operation specified by the user.

The interface apparatus 202 is used to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire the control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general-purpose processing apparatus, and performs basic controls that include, but are not limited to, moving data, starting and/or stopping of the computing apparatus 201. According to different implementations, the processing apparatus 203 may be one or more kinds of general-purpose and/or special-purpose processors, including a CPU (central processing unit), a GPU (graphics processing unit), and the like. These processors include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The storage apparatus 204 is used for storing to-be-processed data, which may be a DRAM (dynamic random access memory). The storage apparatus 204 is a DDR (double data rate) memory with a size of 16 G or more than 16 G generally. The storage apparatus 204 is used for saving data of the computing apparatus 201 and/or the processing apparatus 203.

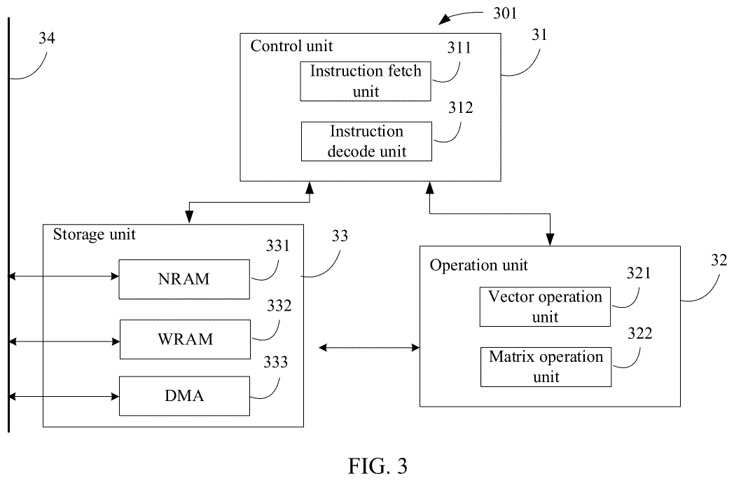

FIG. 3 is a schematic diagram of an internal structure of a processor core of a computing apparatus 201 when it is a single-core or multi-core computing apparatus. The computing apparatus 301 is configured to process input data in the fields of computer vision, speech, natural language, data mining, and the like. The computing apparatus 301 includes 3 units, which are a control unit 31, an operation unit 32, and a storage unit 33.

The control unit 31 is configured to coordinate and control the work of the operation unit 32 and the storage unit 33 to finish a deep learning task. The control unit 31 includes an IFU (instruction fetch unit) 311 and an IDU (instruction decode unit) 312. The instruction fetch unit 311 is configured to acquire an instruction from the processing apparatus 203. The instruction decode unit 312 is configured to decode the instruction acquired and send a decoding result as control information to the operation unit 32 and the storage unit 33.

The operation unit 32 includes a vector operation unit 321 and a matrix operation unit 322. The vector operation unit 321 is used to perform a vector operation, and may support complex operations such as vector multiplication, addition, and nonlinear transformation. The matrix operation unit 322 is responsible for the core computation of the deep learning algorithm, i.e., matrix multiplication and convolution.

The storage unit 33 is used to store or move relevant data and includes an NRAM (neuron random access memory) 331, a WRAM (weight random access memory) 332, and a DMA (direct memory access) 333. The NRAM 331 is used to store an input neuron, an output neuron and an intermediate result after computation; the WRAM 332 is used to store a convolutional kernel of a deep learning network, i.e., a weight; and the DMA 333 is connected to the DRAM 204 through a bus 34, and is responsible for data transfer between the computing apparatus 301 and the DRAM 204.

### Exemplary Type of Convolution Operation

Based on the foregoing hardware environment, in one aspect, an embodiment of the present disclosure provides a computing apparatus configured to perform a convolution operation, so that convolution operations such as a convolution operation performed in a neural network model may be optimized. The convolutional layer in a neural network model may perform a convolution operation. Specifically, by applying a convolutional kernel (also known as a filter, a weight, and the like) to an input feature map (also known as input data, a neuron, or an input neuron) to perform the convolution process, a feature extraction operation may be implemented. There are a plurality of convolutional kernels inside the convolutional layer, and each element that makes up a convolutional kernel corresponds to a weight coefficient and a bias amount bias.

A neural network model may contain various convolution operation layers, such as a convolutional layer that performs a forward and regular 3D convolution operation, and an inverse convolutional layer that performs a depthwise convolution operation. And in a reverse training, it may be necessary to perform a reverse depthwise convolution operation or a cross-product convolution operation. The embodiment of the present disclosure mainly optimizes the conventional 3D convolution operation, and other types of convolution operations may also be optimized without conflict.

In the conventional 3D convolution operation, assuming that a tensor shape of the input feature map in the convolutional layer is denoted as X [N Hi Wi Ci], a tensor shape of the convolution kernel is denoted as K [Co Kh Kw Ci], and an output result is Y [N Ho Wo Co], a simplified mathematical formula of the convolution operation may be expressed as:

Y_{in,jc,jh,jw}=Σ_{0≤ic≤ci,0≤ih≤kh,0≤iw≤kw}X_{in,ic,jh×sh+ih,jw×sw+iw}×K_{jc,ic,ih,iw} (1)

In the above formula, X is the input data, Y is the output data, K is the convolution kernel, Kh is a length of K, Kw is a width of K, sh is a stride in the length direction, sw is a stride in the width direction. The formula ignores bias, pad, and dilation, and assumes that the input data X has already been padded and the convolutional kernel has already been dilated. The formula ignores N and C dimensions; and forward computations of the neural network model are independent in the N dimension but fully connected in the C dimension. When the convolutional kernel is working, it may scan the input feature map according to a certain stride, and perform matrix element multiplication and summation on the input feature map and superimpose the bias of a summation result in a convolutional window. In the conventional 3D convolution operation, element-wise product results in the H, W and Ci directions are accumulated, so the operation is called the 3D convolution operation. However, this 3D convolution operation has a constraint: the size of the convolutional kernel in the Ci dimension is equal to the size of the input feature map in the Ci dimension, so the convolutional kernel does not slide in the Ci direction, which is a kind of pseudo-3D convolution. For simplicity, the above convolution operation is called the 3D convolution operation.

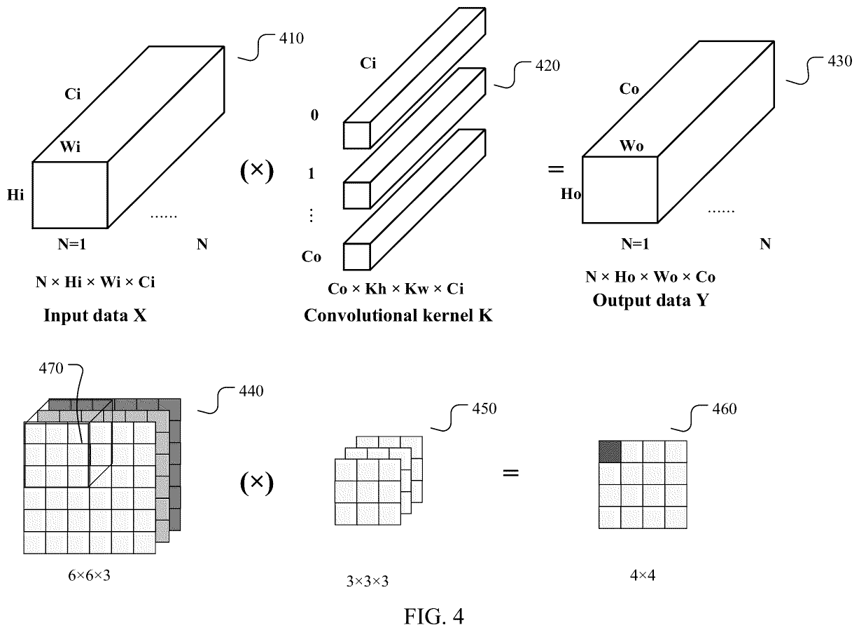

FIG. 4 illustrates an example of an exemplary principle of the conventional 3D convolution operation that may apply an embodiment of the present disclosure.

A piece of four-dimensional input data X of size [N Hi Wi Ci] is exemplarily illustrated in the figure, which may be represented as N three-dimensional rectangles 410 of size Hi×Wi×Ci. A four-dimensional convolutional kernel of size [Co Kh Kw Ci] is exemplarily illustrated in the figure, which may be represented as Co stereoscopic convolutional kernels 420 of size Kh×Kw×Ci. The output data Y may be obtained according to a convolutional result of the input data X with the convolutional kernel K, which is a four-dimensional data of size [N Ho Wo Co], and may be represented as N three-dimensional rectangles 430 of size Ho×Wo×Co.

An exemplary convolution operation is also specifically illustrated in the figure, where the input data is an input feature map 440 of size 6×6×3, and the N dimension is omitted; the convolutional kernel is a stereoscopic convolutional kernel 450 of size 3×3×3, and there are total Co convolutional kernels; and the output data is a 4×4 output feature map 460. The specific computing procedure is as follows:

A convolutional kernel 450 may scan an input feature map 440a according to a certain stride, and perform matrix elements multiplication and summation on the input feature map and superimpose the bias of a summation result in a convolutional window 470. In other words, a value at each position in the output feature map 460 is obtained by performing a two-dimensional operation on a corresponding block of each input feature map with the corresponding convolutional kernel and summing obtained convolutional results. For example, the figure illustrates that a value (i.e., a convolutional output point) at position (0,0) on the output feature map 460 is obtained by performing a two-dimensional convolution operation on a convolutional window 470 framed by a black cube in the input feature map and a stereoscopic convolutional kernel 450 to obtain three values and summing the obtained three values.

To obtain outputs at other positions, a position of the convolutional kernel 450 may be shifted on the input feature map 440; in other words, a convolutional window of a convolutional output point may be shifted. In an example in the figure, a convolutional stride (Sx, Sy) is (1,1), and when the convolution operation is performed after moving one frame to the right in the horizontal direction (width direction) or one frame down in the vertical direction (height direction), a value at a position (0,1) or (1,0) on the output feature map 460a may be obtained, respectively.

From the above description, it can be seen that in a convolutional layer of the neural network, there are N groups of input feature maps, and each group contains Hi×Wi×Ci pieces of information, where Hi and Wi are the height and width of the input feature maps, respectively, and Ci is the number of input feature maps, also known as the number of input channels. The convolutional layer has Ci×Co convolutional kernels of size Kh×Kw, where Ci is the number of input channels, Co is the number of output feature maps (or the number of output channels), and Kh and Kw are the height and width of the convolutional kernel, respectively. The output feature map contains pieces of Ho×Wo×Co information, where Ho is a height of the output feature map, Wo is a width of the output feature map, and Co is the number of output channels. In addition, in the convolution operation, the convolutional stride (Sx, Sy) may also be involved, and the size of the convolutional stride may affect the size of the output feature map.

In the present disclosure, the input feature map, the input data, the neuron, or the input neuron are used interchangeably; the convolutional kernel, the filter or the weight are used interchangeably; and the output feature map, the output data, or the output neuron are used interchangeably. In addition, the H (height) and the Y dimension are used interchangeably, and the W (width) and the X dimension are used interchangeably. Accordingly, the H dimension of the input feature map may be denoted as Hi or Yi, the H dimension of the output feature map may be denoted as Ho or Yo, and the W dimension is similarly denoted. In the embodiment of the present disclosure, each convolutional output point has a corresponding convolutional window, and a shape of the convolutional window is equal to a shape of the convolutional kernel. The value of each convolutional output point corresponds to a result of summing element-wise products of input feature maps and weights within the convolutional window of the convolutional output point.

### Exemplary Computing Apparatus

In the embodiment of the present disclosure, a master-slave architecture computing apparatus may be used to implement the above convolution operation. Further, different data channels may be configured for input feature maps and convolutional kernels to improve access efficiency.

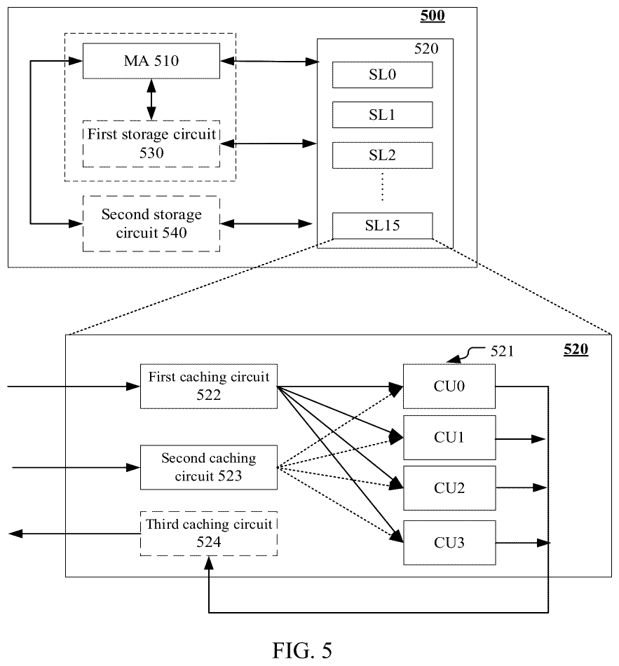

FIG. 5 illustrates an exemplary structural block diagram of a computing apparatus 500 according to an embodiment of the present disclosure. It may be understood that the structure may be considered as a refinement of the internal structure of a computing circuit of the single processing core in FIG. 3, or as a joint functional division block diagram based on the computing circuits of a plurality of processing cores shown in FIG. 3. As shown in FIG. 5, a computing apparatus 500 of an embodiment of the present disclosure may be configured to perform various types of convolution operations. The computing apparatus 500 may include a master processing circuit (MA) 510 and a plurality of slave processing circuits (SL) 520, and there are 16 slave processing circuits SL0 to SL15 illustrated in the figure. It may be understood by those skilled in the art that the number of slave processing circuits may be more or less, depending on the specific hardware configuration, and the embodiment of the present disclosure has no limitation in this respect.

The master processing circuit and the salve processing circuits may communicate with each other through various connections; and a plurality of salve processing circuits may communicate with each other through various connections. In different application scenarios, the connection between the plurality of salve processing circuits may be either a hard connection arranged by a hard wire or a logical connection configured according to, for example, a microinstruction, to form a variety of topologies of a salve processing circuit array, which is not limited in the embodiment of the present disclosure. The master processing circuit and the slave processing circuits may cooperate with each other, thereby realizing a parallel operation.

To support the operation function, the master processing circuit and the slave processing circuits may include various computing circuits, such as a vector operation unit and a matrix operation unit. The vector operation unit is used to perform a vector operation, and may support complex operations such as vector multiplication, addition, and nonlinear transformation. The matrix operation unit is responsible for core computation of the deep learning algorithm, such as matrix multiplication and convolution.

The slave processing circuits may be used, for example, to perform an intermediate operation on corresponding data in parallel according to an operating instruction to obtain a plurality of intermediate results, and to transmit the plurality of intermediate results back to the master processing circuit.

By setting the computing apparatus 500 in a master-slave structure (such as a single-master multi-slave structure, or a multi-master multi-slave structure, which is not limited in the present disclosure), data may be sliced according to a computing instruction of a forward operation, so that a plurality of salve processing circuits are used to perform parallel operations on the parts that require large amount of computation, thus increasing operation speed, saving operation time, and then reducing power consumption.

In some embodiments of the present disclosure, by utilizing different data channels to transmit input feature maps and weights, multiple ways of reusing input feature maps and weights may be supported, thus reducing the amount of data access during computation and improving processing efficiency.

Specifically, the computing apparatus 500 may further include a first storage circuit 530 and a second storage circuit 540 for storing data transmitted via different data channels, respectively. Optionally, the first storage circuit 530 and the second storage circuit 540 may be two storage blocks formed by dividing a same memory, or may be two separate memories, which are not specifically limited herein.

The first storage circuit 530 may be used to store multicast data, in other words, data in the first storage circuit may be transmitted to a plurality of slave processing circuits via a broadcast bus, and the slave processing circuits receive the same data. It may be understood that broadcast and multicast may be achieved through the broadcast bus. The multicast refers to a communication mode in which a piece of data is transmitted to a plurality of slave processing circuits; and the broadcast refers to a communication mode in which a piece of data is transmitted the to all slave processing circuits. The broadcast is a special case of the multicast. Since both multicast and broadcast correspond to a one-to-many transmission mode, no deliberate distinction is made between the two herein, and broadcast and multicast may be collectively referred to as multicast, the meaning of which may be clarified by those skilled in the art based on the context.

The second storage circuit 540 may be used to store distribution data, in other words, data in the second storage circuit may be transmitted separately to different slave processing circuits, and each of the slave processing circuits receives different data.

By providing the first storage circuit and the second storage circuit separately, data to be operated may be transmitted in different modes, thereby reducing the amount of data access by reusing the multicast data among the plurality of slave processing circuits.

In some embodiments, the input feature maps may be determined as multicast data and stored in the first storage circuit to transmit the data to a plurality of scheduled slave processing circuits by the broadcast mode during operating. Correspondingly, the convolutional kernel may be determined as distributed data and stored in the second storage circuit. The distributed data may be distributed to corresponding slave processing circuits before operating.

FIG. 5 also illustrates a schematic diagram of an internal structure of a salve processing circuit SL according to an embodiment of the present disclosure. As shown in the figure, each slave processing circuit 520 may include a plurality of computing circuits CU 521, a first caching circuit 522, and a second caching circuit 523. Four computing circuits CU0 to CU3 are illustrated in the figure. It may be understood by those skilled in the art that the number of computing circuits may be more or less, depending on the specific hardware configuration, and the embodiment of the present disclosure has no limitation in this respect.

In some embodiments, the first caching circuit 522 may be used to cache weights or input feature maps assigned to the slave processing circuit. Accordingly, the second caching circuit 523 may be used to cache input feature maps or weights assigned to the slave processing circuit. Both the first caching circuit 522 and the second caching circuit 523 are used to select data involved in the operation. Data of the first caching circuit 522 may be a plurality of data lines from, for example, the first storage circuit 530 or the second storage circuit 540, and correspondingly, data of the second caching circuit 523 may be a plurality of data lines from, for example, the second storage circuit 540 or the first storage circuit 530. Depending on specific reusing methods, these data lines may be distributed to a corresponding computing circuit CU 521 or broadcast to all CUs 521 inside the slave processing circuit 520 during operating.

Each of the computing circuits CU 521 is used to, in each operation cycle, perform an element-wise multiplication and accumulation on data lines selected from the first caching circuit and data lines selected from the second caching circuit, respectively.

By providing the first caching circuit and the second caching circuit separately, data to be operated may be transmitted in different modes, thereby reducing the amount of data access by reusing the data among the plurality of computing circuits in a single slave processing circuit.

The slave processing circuit 520 may also include a third caching circuit 524 for caching computation results of each computing circuit CU 521.

It may be understood that although the processing circuits and the storage circuits are shown as individual units in FIG. 5, the storage circuits and the processing circuits may also be combined into a single unit depending on the configuration. For example, the first storage circuit 530 may be combined with the master processing circuit 510; the second storage circuit 540 may be shared by the plurality of slave processing circuits 520, and each slave processing circuit may be allocated with a separate storage area for accelerating access, which is not limited in the embodiment of the present disclosure. In addition, in the computing apparatus, the master processing circuit and the salve processing circuits may belong to different units of the same processor or chip, or to different processors, which is not limited in the present disclosure.

### Exemplary Convolutional Optimization Scheme

In an embodiment of the present disclosure, the multidimensional data involved is characterized in terms of dimensions as (N,H,W,C) or (Co,H,W,Ci), which represents the order in which the data is stored in the memories. It may be understood that although the multidimensional data has multiple dimensions, since the layout of the memory is always one-dimensional, there is a correspondence between the multidimensional data and a storage order of the memory. The multidimensional data is usually allocated in continuous storage space, in other words, the multidimensional data may be extended one-dimensionally and stored on the memory. For example, in the embodiment of the present disclosure, the input feature maps may be stored sequentially in a low-dimensional (here C/Ci is the lowest dimension) prioritized manner. Adjacent dimensions are dimensions that are next to each other in the dimensional representation of the multidimensional data, for example, W and Ci are adjacent to each other. When the storage order is consistent with the dimension order, positions of adjacent dimensions on the memory are consecutive. Here W and Ci are adjacent to each other and data in the two dimensions are also consecutive on the memory.

In an intelligent processor, for computing power needs and area power overhead considerations, a main computing circuit of the hardware a multiply-add operator for vectors. Implementing support for various types of convolution algorithms in the hardware design essentially maximizes the extraction of a multiply-add operation in an algorithm and enables efficient exchange of input and output data of the multiply-add operation between an on-chip RAM (such as the NRAM and the WRAM in FIG. 3) and the operator via data channels.

Data is stored in the hardware line by line (caching lines), and the efficiency of reading, writing, and computing is highest when the whole line is aligned, so in order to make full use of bandwidth and meet the requirements, such as the amount of access, of an operator array, it is usually necessary to perform an vectorized alignment on the data. An artificial intelligence chip is usually designed with the Ci dimension as the lowest dimension, which is the above NHWC placement order, where the data in the Ci dimension is consecutive. Thus, the vectorized alignment requires that the size of the Ci dimension is aligned to a specified value, such as an alignment value M, so that data access is performed in terms of that alignment value M, where M may also be referred to as the maximum amount of data computed by the hardware at a time. Based on different hardware designs, M may have different values, such as 64 bit, 128 bit, 256 bit, 512 bit, and the like. Typically, the size of an input port of the operator array is also related to M. For example, when the bit width of the input data is symmetrical, the size of the input port of the operator array is usually 2 times that of M, which allows for the simultaneous processing of input feature map data and weight data of an alignment value of M at one time. It is easier to satisfy the above alignment requirement when the Ci dimension of the input feature map is large.

When the Ci dimension of the input feature map is small or when a remainder obtained by dividing Ci with M is small, for example, when the Ci dimension of the input feature map or a remainder obtained by dividing Ci with M is less than the size of one caching line, the data in the Ci dimension is required to be padded to one line of data (such as 512 bits), in other words, invalid data 0 is filled. This padding way results in a large number of redundant computations, leading to a waste of resources and a reduction in the operating efficiency.

A lite convolution scheme is proposed in the present disclosure, which is suitable for the case of a small channel C, in which data involved in the operation is spliced based on a slicing unit and stored in an order of converted dimensions. The amount of data contained in a slicing unit may be set to the alignment value M processed by the hardware at a time, so that the computation may be performed in units of a slicing unit, and in this way, the computing power of the hardware may be fully utilized to avoid or reduce the invalid computation.

However, in this lite convolution scheme, both the input feature map and the convolutional kernel are required be pre-processed by software for tiling and dimension conversion, and the output feature map is also required to be processed by software for corresponding tiling and dimension conversion, which undoubtedly increases the complexity of the software. In addition, the software is required to perform the alignment processing during these tiling and dimension conversion processes. Further, the lite convolution scheme only supports convolution operations with a convolutional stride of 1 in both the width and height directions.

In view of this, in order to further optimize the convolution operation and reduce software complexity, an embodiment of the present disclosure provides a width dimension folding convolution scheme, which eliminates the need for the software to perform data tiling and dimension conversion processing by compensating the data in the width W dimension, which is contiguous with the Ci dimension of the input channel of the input feature map, to the Ci dimension only when needed.

Specifically, some embodiments provide a computing apparatus, including a plurality of slave processing circuits, where each slave processing circuit includes a first caching circuit, a second caching circuit, and a plurality of computing circuits. The first caching circuit is used to cache a plurality of input feature lines on which a convolution operation is to be performed, where one of the input feature lines includes the data amount of PcixWs=M in an input feature map, where Pci is a slice granularity of a Ci dimension of an input channel, Ws is a folding multiplier of a W dimension of the width, and M is the data amount of data processed by hardware at one time; the second caching circuit is used to cache weight data on which the convolution operation is to be performed; and each of the computing circuits is used to perform, at each computation, an element-wise multiplication and accumulation on an input feature line selected from the first caching circuit and an extended weight line selected or generated from the second caching circuit, respectively, where one extended weight line consists of a convolutional kernel sliced in a Ci dimension according to Pci, or, alternatively, consists of a convolutional kernel aligned to a column of data blocks of Pci that is replicated and extended into Ws columns.

In some embodiments, output data of a previous layer of some convolutional layers (such as an FUCONV layer) has been sliced into two segments in the Ci dimension, each with a ci size of 32B (such as a data type int8) or 64B (such as a data type int16). At this point, the slice granularity Pci may follow the size of the individual segments, i.e., 32B or 64B.

In yet further embodiments, the slice granularity Pci of the input channel may be determined based on the size of the Ci dimension of the input channel of the input feature map and the amount of data M processed by the hardware at one time; and subsequently, a folding multiplier Ws of the width W dimension of the input feature map may be determined based on the slice granularity Pci. In some embodiments, Ws=M/Pci. It is understood that the convolution scheme of the embodiment of the present disclosure may be adapted to any Ci size by slicing the Ci dimension according to the slice granularity. Moreover, it is also understood that the maximum slice granularity Pci does not exceed the hardware's one-time processing alignment value M (or called a base alignment value, i.e., the amount of data processed by the hardware at a time). As a result, with different ranges of values for Ci, a suitable Pci may be chosen, and the alignment requirement for the Ci dimension may be reduced by padding data in the adjacent W dimension to the Ci dimension.

In some embodiments, the slice granularity Pci of the input channel may be chosen to be M/2ⁿ, n=0, 1, 2, . . . , thus facilitating the folding of data 2″ times from the second-lowest storage dimension W to the lowest storage dimension Ci. Table 1 illustrates several folding schemes corresponding to the slice granularity Pci of the input channel, assuming M=64B.

TABLE 1

| | Slice Granularity (Pci) | | | | |
|---|---|---|---|---|---|
| | 4B | 8B | 16B | 32B | 64B |
| Ws (W collapsed) | 16 | 8 | 4 | 2 | 1 |

From the Table 1, it can be seen that the smaller the slice granularity of the input channel, the more copies of data padded from the Wi dimension to the Ci dimension, and the larger the constrained size of the alignment on Wi, in which Wi/Ws≥1 is required to be met.

It can be understood that although a theoretical slice granularity may be M/2ⁿ, considering the requirements on W dimension, the instruction cost, and the actual Ci value range when the slice granularity is too small, only some values in M/2ⁿ may be selected as an alternative slice granularity. In an example that M=64B, the alternative slice granularity may include, such as 64B, 32B, 16B and 8B.

Different splice granularities may be applied to different computing scenarios, thereby achieving varying degrees of performance optimization. Specifically, in some embodiments, the slice granularity Pci of the input channel may be selected as follows:
aligning the lowest storage dimension Ci of the input feature map to each alternative slice granularity separately; and
selecting an appropriate slice granularity considering the amount of aligned pad aligned to each alternative splice granularity and the size of the corresponding slice granularity, for example, an alternative slice granularity where the amount of aligned pad is within a predetermined range and as large as possible is used as Pci.

For example, in the case of the same amount of aligned pad, the larger slice granularity is preferred; or in the case of different amounts of aligned pad, the slice granularity with the smallest amount of aligned pad is preferred; or in the case of a small difference in the amount of aligned pad (for example, the amount of aligned pad is within a predetermined range, such as no more than 16B), the larger slice granularity is preferred.

Although rules for selecting the slice granularity Pci of the input channel are listed above, however, these rules are only preferred embodiments for selecting the preferred slice granularity of the input channel that best suits the current value of Ci. The application of the above rules is described below in conjunction with several examples. In all examples, it is assumed that M=64B, the alternative slice granularity may include 64B, 32B, 16B and 8B.

In an example, it is assumed that Ci=48B, no complementary zero is required to be aligned to 8B and 16B, and 16B is required to be aligned to 32B and 64B. At this point, a larger slice granularity that does not require zero-completion may be preferred as the Pci, i.e., 16B.

In another example, it is assumed that Ci=28B, 4B of complementary zeros are required to be aligned to 8B, 16B, and 32B, and 36B of complementary zeros are required to be aligned to 64B. At this point, a larger slice granularity with smaller amount of aligned pad may be preferred as the Pci, i.e., 32B.

In another example, it is assumed that Ci=49B, 7B of complementary zeros are required to be aligned to 8B, and 15B of complementary zeros are required to be aligned to 16B, 32B, and 64B. At this point, the difference in the amount of aligned pad is only 8B, which is within an acceptable range, so that a larger slice granularity of 64B may be preferred.

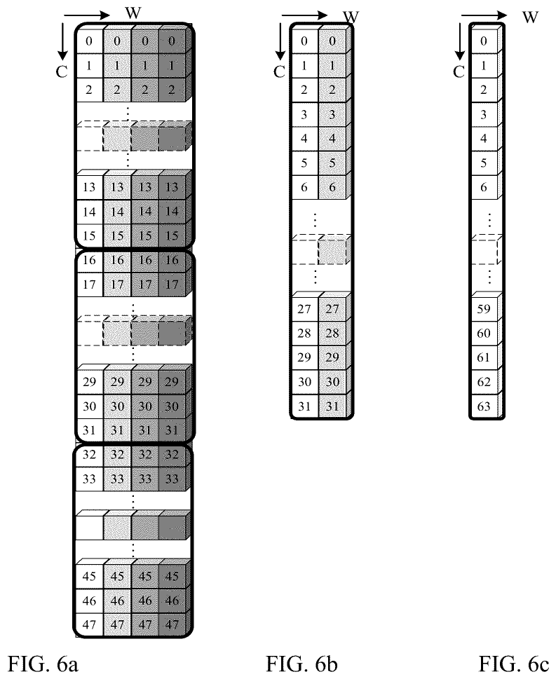

FIG. 6a-FIG. 6c illustrate several examples of data width dimension folding according to embodiments of the present disclosure. In these examples, it is also assumed that M=64B.

As shown in FIG. 6a, the W dimension is required to be collapsed by a factor of 4 when the determined slice granularity of the input channel Pci=16B. In other words, a shape of a data line is Wi*Ci−4×16B. When the size of the Ci dimension exceeds 16B, data on 1*Ci is sliced in a plurality of data lines. For example, when Ci=48B, data on the Ci is sliced in 3 data lines. The figure shows data included in each of the 3 data lines in rounded rectangular boxes, where 3 may also be referred to as the number of slicing blocks in the Ci dimension.

As shown in FIG. 6b, the W dimension is required to be collapsed by a factor of 2 when the determined slice granularity of the input channel Pci=32B. In other words, a shape of a data line is Wi*Ci=2×32B. Similarly, when the size of the Ci dimension exceeds 32B, data on 1*Ci is sliced in a plurality of data lines. For example, when Ci=96B, data on the Ci is sliced in 3 data lines. Only a single data line is shown in the figure.

As shown in FIG. 6c, when the determined slice granularity of the input channel Pci=64B, the W dimension is required to be collapsed by a factor of 1, in other words, the W dimension does not need to be collapsed. At this point, a shape of a data line is Wi*Ci=1×64B. Similarly, when the size of the Ci dimension exceeds 64B, data on 1*Ci is sliced in a plurality of data lines. For example, when Ci=128B, data on the Ci is sliced in 2 data lines. Only a single data line is shown in the figure.

As mentioned above, in some embodiments, the master processing circuit 510 in the FIG. 5 may determine the input feature maps as multicast data and stored in the first storage circuit 530 to transmit the data to a plurality of scheduled slave processing circuits by the broadcast mode during operating. As can be seen from the previously described width folding scheme, the format of the input data does not require tiling and dimension conversion processing because W and C are continuous dimensions, and thus the original input data format HWC may be received directly. Accordingly, in the first storage circuit 530, the input feature map may be stored therein in an original format (such as HWC).

When the input feature map is read from the first storage circuit 530 and broadcast to the plurality of slave processing circuits, the aforementioned alignment processing may be performed. In other words, during the transmission from the first storage circuit to a caching circuit (such as the first caching circuit) within the slave processing circuit, the master processing circuit 510 may control to perform the alignment on the Ci dimension to align to the determined slice granularity Pci of the input channel, and then a corresponding amount of data in the Wi dimension is folded to form a data line, and a data line is taken as the minimum granularity and broadcast and transmitted to the slave processing circuit.

It is understood that in the aforementioned example of the FUCONV convolutional layer, the input feature map, i.e., output data of the previous layer, which has been sliced into two segments in the Ci dimension, and thus the data format may be [2,hi, wi,32B] or [2,hi, wi,64B].

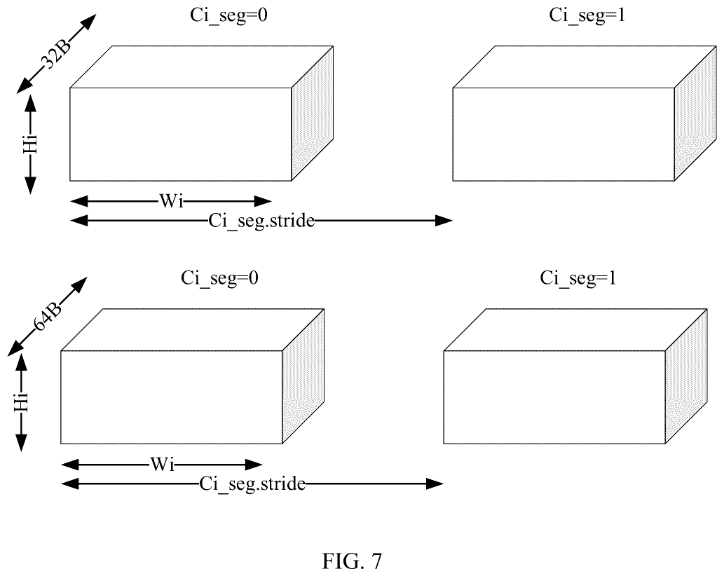

FIG. 7 schematically illustrates an exemplary method of storing input feature maps according to some embodiments of the present disclosure. As shown in the figure, the input feature maps may be stored in two segments according to Ci. A first address interval of the two segments is Ci_seg.stride:, and the ci size of each segment is 32B or 64B. For a 32B segment, a shape of a data line is Wi*Ci=2×32B; for a 64B segment, a shape of a data line is Wi*Ci=1×64B.

Thus, the storage format of the input feature maps and the folding processing on the input feature maps via the data channel in the embodiment of the present disclosure are described above.

### Exemplary Storage Method of the Convolutional Kernel

A computation of convolution involves each input feature map undergoing multiply-add operations with each convolutional kernel for Co to output Co output feature maps. However, it is not always possible to store all sizes of convolutional kernels and input feature maps in on-chip space at the same time, so there are a series of repeated loading of input feature data or weight data on the hardware, and how to balance the repeated loading of input feature data or weight data may have a certain impact on the efficiency of the computation. In the actual operation, in order to reduce the frequent off-chip access, different reuse modes may be adopted according to scale characteristics of data involved in the operation.

According to the principle of the convolution operation described above, it can be seen that operating results in the Co dimension are not required to be accumulated, and thus operations on different Co may be performed relatively independently on different computing circuits. In other words, convolutional kernels of different Co may be assigned on different computing circuits, and the same input feature map is used for operating, at this point, the input feature map is reused among the operating units, and the reuse times Rn=Ns, where Ns is the number of computing circuits.

In some embodiments of the present disclosure, a Covalue assigned to each slave processing circuit for processing may be determined based on the size of Co dimension of the output channel of the convolutional kernel and the number of schedulable slave processing circuits Ns.

To simplify the scheduling of the slave processing circuits, in some embodiments, based on the size of the Co dimension of the output channel of the convolutional kernel, the Co value assigned to each slave processing circuit may be allocated according to a scheme that each slave processing circuit processes one Co value per turn. When Co does not exceed the number of schedulable slave processing circuits, Co slave processing circuits may be scheduled, and each slave processing circuit processes one Co value. For example, when Co=8, 8 slave processing circuits may be scheduled, and each slave processing circuit processes one Co value. When Co exceeds the number of schedulable slave processing circuits, Co slave processing circuits may be scheduled, the operation may be completed in multiple rounds. Each round of operation schedules as many slave processing circuits as possible, and each slave processing circuit processes one Co value. For example, when Co=24, a first round of operation may schedule all available 16 slave processing circuits to process the first 16 Co values; and a second round of operation may schedule 8 slave processing circuits to process the last 8 Co values, thus completing all operations.

In some embodiments, the data of the input feature map may be further reused in the H dimension, thus further reducing the amount of access. In these embodiments, considering that some storage circuits only support reading data in the order from smallest to largest according to the address, in order to facilitate the reading of the corresponding weight data in the H dimension, it is necessary to store the data in the H dimension upside down, which will be described in detail later in conjunction with the convolution operation process.

As mentioned above, in some embodiments, the convolution kernel may be determined as distributed data and stored in the second storage circuit 540 to be distributed to or read by the corresponding slave processing circuit before the operation. The second storage circuit 540 may be shared by a plurality (such as Ns) of slave processing circuits 520, and a separate storage area is assigned to each slave processing circuit, such that data required for the computation of each slave processing circuit only needs to be read from its corresponding storage area, accelerating the access speed. When the convolutional kernel is tiled and stored according to the Co dimension, the convolutional kernel corresponding to the Co value assigned to a certain slave processing circuit may be stored in a corresponding storage area of the second storage circuit. Since the Co dimension is the highest storage dimension of the convolutional kernel, there is no need to perform processing such as dimension conversion to perform the tiling and storage operations on the Co dimension; instead, it is sufficient to directly store the data of the convolutional kernel corresponding to the Co value in the original format (such as KhKwCi) in the second storage circuit.

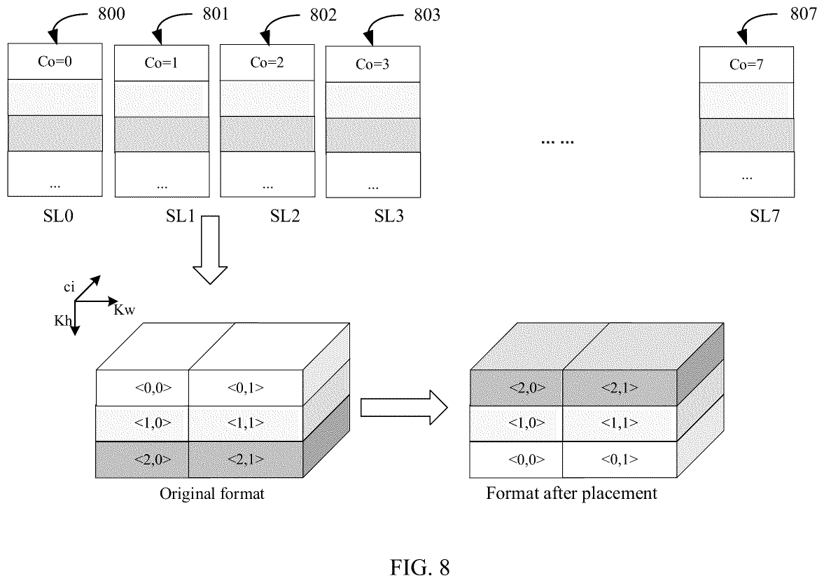

FIG. 8 illustrates a schematic diagram of a convolutional kernel storage method according to an embodiment of the present disclosure. In the example, it is assumed that the size of the Co dimension of the convolutional kernel is 8, so that 8 slave processing circuits are scheduled to perform the operation. Eight storage areas 800˜807 allocated for, for example, when Ns=8, 8 slave processing circuits SL0˜SL7 are exemplarily shown in the figure. A convolutional kernel corresponding to the Co value to be processed by the slave processing circuit is stored in each storage area.

In an example, consecutive Co values are assigned to the 8 SLs one by one sequentially (i.e., in intervals of 1). For example, the figure illustrates that a convolutional kernels with that Co=0˜7 are stored sequentially on 8 storage areas 800˜807. Further, in each storage area, the convolutional kernel is stored in the H direction upside down, in other words, the convolutional kernel is stored in the order from the largest index to the smallest index in the height dimension Kh, so that it is convenient to load the convolutional kernel to the second caching circuit and read the convolutional kernel in the order from smallest to largest according to an address.

Similarly to the input feature map, similar slice and alignment operations are also performed on each convolutional kernel with Co value in the Ci dimension. Similarly, in the aforementioned example of the FUCONV convolutional layer, the convolutional kernel has been sliced into two segments in the Ci dimension, and is therefore similarly stored in segments.

In some embodiments, when the convolutional kernel is read from the second storage circuit and distributed to the corresponding slave processing circuit, the slice and alignment operations are performed on the Ci dimension as needed. In other words, during the transmission from the second storage circuit to a caching circuit (such as the second caching circuit) within the slave processing circuit, the alignment is performed on the Ci dimension to align to the determined slice granularity Pci of the input channel. Unlike the input feature map, the convolutional kernel is not required to be folded in the W dimension, but is replicated and extended according to the folding multiplier Ws, which can be seen in the subsequent description of the convolution operation process.

### Exemplary Convolution Operation Process in a Single Slave Processing Circuit

When the input feature map is broadcast to the scheduled slave processing circuits, the convolutional kernel is distributed to a corresponding slave processing circuit. Each slave processing circuit may perform the convolution operation on the corresponding data of the input feature map and the convolutional kernel, and then the master processing circuit may concatenate operating results returned from a plurality of processing circuits to get an output feature map obtained by performing the convolution operation on the input feature map and the convolution kernel. Specifically, a plurality of computing circuits CUs of the slave processing circuits as well as individual caching circuits (see FIG. 5) may be utilized to perform specific convolution operations. Depending on the space size of the caching circuits of the slave processing circuits and the computing power limit of the computing circuits, it is usually necessary to perform multiple operation cycles in each round of operation to complete the required operation.

In some embodiments, the first caching circuit may be configured to cache an input feature map from the first storage circuit; accordingly, the second caching circuit may be configured to cache a convolution kernel, i.e., weight data, from the second storage circuit. Each of the computing circuits CU is used to, in each operation cycle, perform an element-wise multiplication and accumulation on data lines (such as input feature lines) selected from the first caching circuit and data lines (such as partial weight lines or extended weight lines) selected from the second caching circuit, respectively. For simplicity, the following description is directed to a processing for one Co value within a single slave processing circuit SL, and it may be appreciated that similar processing is performed within other SLs.

From the above mentioned principle of the convolution operation, the value of each convolutional output point in the output feature map corresponds to a result of summing the element-wise product of the input feature maps and weights within the convolutional window of the convolutional output point. In other words, a value of a single output point an accumulation of element-wise product of each part.

In some embodiments, for a single output point in the output feature map, the value of that output point may be computed in the following order and through multi-layer cycles. The Kw dimension of the convolutional kernel is taken as an inner-layer cycle to compute a partial sum of the output point, and the cycle number Nkw=min (Kw, Kmax), where Kw is a size of the width dimension of the convolutional kernel, and Kmax is the maximum width of the convolutional kernel supported by the slave processing circuits; the number Bci of blocks tiled according to Pci in the Ci dimension of the convolutional kernel is taken as a middle-layer cycle to compute a partial sum of the output points, and the cycle number Nci=Bci=ceil (Ci/Pci); the Kh dimension of the convolutional kernel is taken as an outer-layer cycle to compute a partial sum of this output point, and the cycle number Nkh=Kh, where Kh is the size of the height dimension of the convolutional kernel; and each partial sum is accumulated to get the value of the output point, where the total cycle number Ncycle=Nkw*Nci*Nkh.

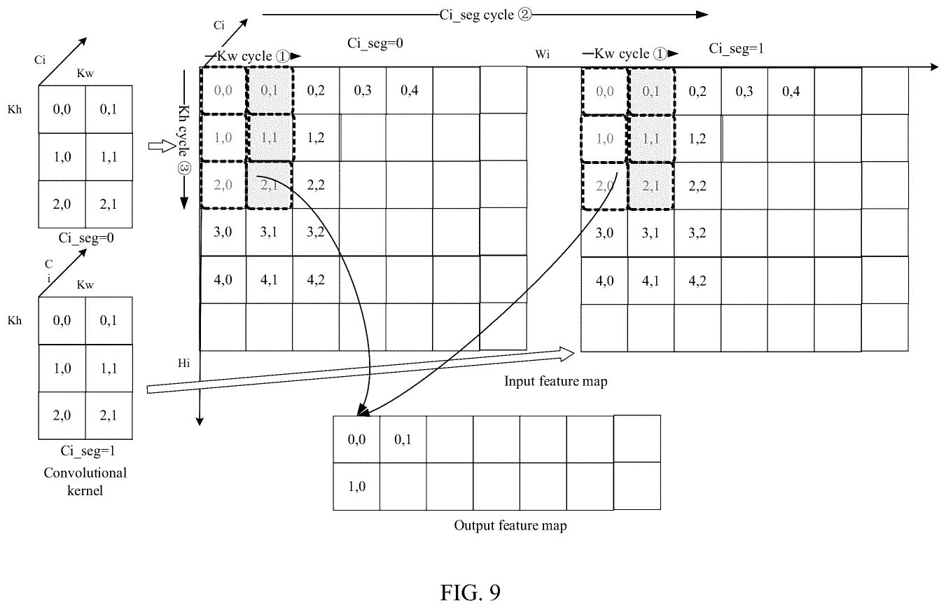

FIG. 9 illustrates an exemplary cycle schematic diagram for computing a single convolutional output point according to an embodiment of the present disclosure. In the example, it is assumed that the Kw of the convolutional kernel is equal to 2, the Ky of the convolutional kernel is equal to 3, and Ci is tiled into two segments, where the size of each segment is 32B; the Wi of the input feature map is equal to 20, the Hi of the input feature map is equal to 20, and Ci is similarly tiled into two segments, where the size of each segment is 32B; and a convolutional stride of the width Sx and a convolutional stride of the height direction Sy are equal to 1. The figure illustrates the composition of each partial sum of a first output point on the output feature, each data point is represented by the coordinates <h,w> of its height and width dimensions, and the size of each data point in the ci direction is Pci.

In the inner-layer cycle in the Kw dimension, input feature lines and extended weight lines are selected by sliding synchronously in the width dimension with 1 as the stride on the first caching circuit and the second caching circuit to compute different partial sums of a same output point. A sliding number of the inner-layer cycle, i.e., the cycle number Nkw=min (Kw, Kmax), where Kw is the width dimension of the convolutional kernel, and Kmax is the maximum width value of the convolutional kernel supported by the slave processing circuits.

In some embodiments, Kmax may be determined as follows:

$$K max = L 1 * Ws - Ncu * Ws + 1 ,$$

where L1 is the size of the first caching circuit in units of data line, Ncu is the number of scheduled computing circuits, and Ws is the folding multiplier of the width dimension. For example, in a case that L1=8, in other words, the first caching circuit has 8 data lines and Ncu=4, when Ws=4, Kmax=17; when Ws=2, Kmax=9; when Ws=1, Kmax=5. It can be seen that in most cases, the width of the convolutional kernel, Kw, does not exceed Kmax, so Nkw=Kw.

As shown in FIG. 9, in this example, the inner-layer cycle number Nkw in the Kw dimension is equal to 2, i.e., Nkw=Kw=2. Specifically, an input feature data point <0,0> and a weight data point <0,0> are selected at a first cycle to perform the element-wise multiplication and accumulation to obtain a first partial sum; one step is slide to the right at a second cycle, and then a input feature data point <0,1> and a weight data point <0,1> are selected to perform the element-wise multiplication and accumulation to obtain a second partial sum It can be seen that the first partial sum and the second partial sum belong to a partial sum of the first output point <0,0>.

In the middle-layer cycle, the cycle is performed according to the number of segments Bci tiled based Pci in the Ci dimension. In an example shown in FIG. 9, Nci=Bci=2. Therefore, the input feature maps and the weights are selected synchronously. At a first cycle, data may be selected from a first segment Ci_seg=0 for performing the element-wise multiplication and accumulation to get a third partial sum; and at a second cycle, data may be selected from a second segment Ci_seg=1 for performing the element-wise multiplication and accumulation to get a fourth partial sum. From the principle of the convolution operation, products in the Ci dimension are required to be accumulated. Therefore, the third partial sum and the fourth partial sum belong to the partial sum of the first output point <0,0>. It is understood that the third partial sum is essentially the sum of the first partial sum and the second partial sum obtained by the inner-layer cycle. The fourth partial sum is similar to the third partial sum.

In the outer-layer cycle in the Kh dimension, each partial sum may be computed by performing Kh cycles in the H direction according to the size of Kh. As shown in the FIG. 9, Kh=3, 3 times of cycles are required to be performed. At a first cycle, weights are selected from a line that Kh=0 and input feature maps are selected from a line that Hi=0 for performing the element-wise multiplication and accumulation to get a fifth partial sum; at a second cycle, weights are selected from a line that Kh=1 and input feature maps are selected from a line that Hi=1 for performing the element-wise multiplication and accumulation to get a sixth partial sum; and at a third cycle, weights are selected from a line that Kh=2 and input feature maps are selected from a line that Hi=2 for performing the element-wise multiplication and accumulation to get a seventh partial sum. It can be seen that the fifth partial sum, the sixth partial sum, and the seventh partial sum belong to the partial sum of the first output point <0,0>. It is understood that the fifth partial sum is essentially the sum of the third partial sum and the fourth partial sum obtained by the middle-layer cycle. The sixth partial sum and the seventh partial sum are similar to the fifth partial sum. Since data in the Kh dimension does not undergo any dimensional folding or slicing, the convolution scheme of the embodiments of the present disclosure may support a convolutional stride of any value in the Kh dimension.

It can be understood that when the width size of the convolutional kernel exceeds Kmax, the convolutional kernel is required to be sliced in the Kw direction according to this maximum convolutional kernel width value. In this case, in addition to the three-layer cycle mentioned above, the cycle is further processed according to the slice of Kw.

As mentioned above, in some embodiments, the data of the input feature map may be further reused in the H dimension, thus further reducing the amount of access. Specifically, the input feature line selected each time may be reused rn times, and corresponding rn extended weight lines corresponding to the convolutional kernel in the height dimension may be carried out the element-wise multiplication and accumulation respectively, so as to obtain continuous rn output blocks in the height dimension of the output feature map, where rn is determined according to the size Kh of the height dimension of the convolutional kernel and the convolutional stride Sy of the height direction of the convolution operation.

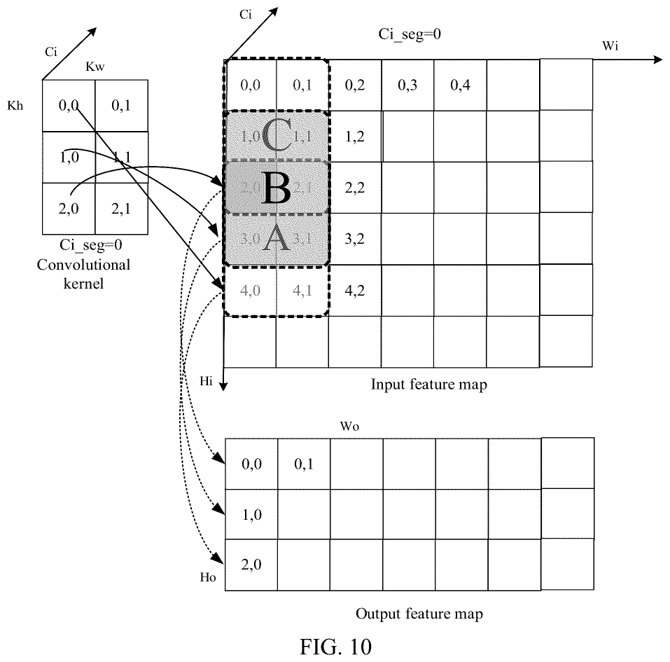

FIG. 10 illustrates a schematic diagram of an operation for reusing data of an input feature map in an H dimension according to some embodiments of the present disclosure. The parameter configuration of this example is similar to FIG. 9.

As shown in the figure, when the element-wise multiplication and accumulation is performed on a same input feature data point with traversed Kh weight points in the H dimension to obtain partial sums, which belong to different output points. To avoid computation overflow, an input feature data point <2,0> is used as an example. Equivalent to a case of a convolutional window A, the element-wise multiplication and accumulation is performed on the input feature data point <2,0> with the weight data point <0,0> to obtain an eighth partial sum, which belongs to an output point <2,0>; equivalent to a case of a convolutional window B, the element-wise multiplication and accumulation is performed on the input feature data point <2,0> with the weight data point <1, 0> to obtain a ninth partial sum, which belongs to an output point <1, 0>; and equivalent to a case of a convolutional window C, the element-wise multiplication and accumulation is performed on the input feature data point <2,0> with the weight data point <2,0> to obtain a tenth partial sum, which belongs to an output point <0,0>.

It can be seen that the reuse times of input feature maps in the H dimension depend on the maximum overlap times of adjacent convolutional Windows in the H dimension. For example, in the above example, Kh=3, Sy=1, the input feature data point <2,0> is simultaneously covered by three convolutional Windows corresponding to the three output points (i.e., the output points <2,0>, <1,0>, and <0,0>), and may therefore be reused three times. It can be understood that when Sy>1, the reuse times rn is less than Kh, rn=kh−sy+1; and some data points are not covered by the convolutional window, in other words, those data points are not required to be reused.

The above describes the computation of partial sums by performing the cycle many times to obtain a value of a single output point, and the input feature maps are reused in the H dimension during the computation of a single output point, so that a plurality of output points/output blocks in the H dimension may be computed.

In order to make full use of parallel operating characteristics of a plurality of computing circuits in the slave processing circuits, an output feature map may be computed in parallel by a plurality of computing circuits CUs in a single slave processing circuit. Considering the dimensional order in which the output feature map is stored as well as the W folding of the input feature map, to simplify the output processing, preferably, Ncu output blocks are successively divided in the Wo dimension to be operated in parallel by Ncu computing circuits, respectively, and each output block corresponds to an operating result of one input feature data line. In some embodiments, Ncu adjacent input feature lines are selected in sequence from the first caching circuit and distributed to Ncu computing circuits, and a corresponding extended weight data line is selected or generated from the second caching circuit and broadcast to Neu computing circuits, so that the parallel computation of Neu output blocks may be realized by reusing the weight data.

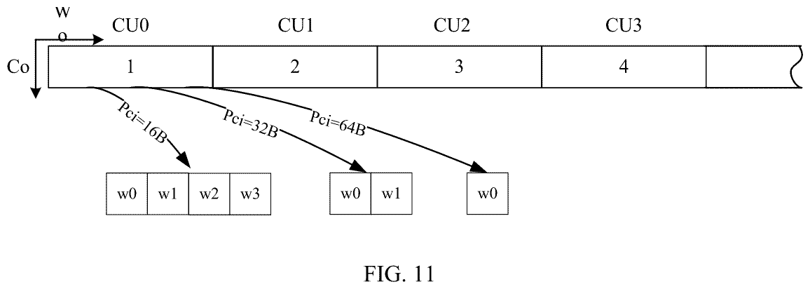

FIG. 11 illustrates a schematic method of slicing an output feature map according to an embodiment of the present disclosure. For simplicity, FIG. 11 only shows a slicing method of the output feature map with a Co value in the Wo dimension. In this example, it is assumed that Ncu=4, the Wo dimension is divided into 4 output blocks in turn, each of which corresponds to an operating result of one input feature data line.

Further, depending on the different data formats within a single data line of the input feature map, different numbers of output points may be included in the output block computed by a single computing circuit CU. Specifically, each output block includes Ws consecutive output points in the width Wo dimension according to the width dimension folding multiplier Ws determined earlier. For example, when the Ci of the input feature map is sliced according to the granularity Pci, where Pci=16B, a data line includes 4 Wis, and output points on 4 Wo dimensions may be computed; when the Ci of the input feature map is sliced according to the granularity Pci, where Pci=32B, a data line includes 2 Wi, and output points on 2 Wo dimensions may be computed; and when the Ci of the input feature map is sliced according to the granularity Pci, where Pci=64B, a data line includes 1 Wi, and output points on 1 Wo dimension may be computed. FIG. 11 further illustrates the different composition of a single output block in the above three cases, specifically, a single output block may be composed by 4 Wo output points, 2 Wo output points, or 1 Wo output point.

In order to support a single CU to simultaneously compute one or more Wo output points that may be included in an output block, in some embodiments, the corresponding weight data may be composed as follows: when the convolutional kernel in the second storage circuit is distributed to the second caching circuit of each salve processing circuit, in addition to aligning the Ci dimension of the convolutional kernel to Pci, a column of Ci data sliced according to Pci or aligned to Pci in the Ci dimension is replicated and extended into Ws columns to form an extended weight data line, which is stored in the second caching circuit. In other words, a shape of an extended weight data line is Ws*Pci, which may correspond to an input feature data line. As a result, an extended weight data line may be selected from the second caching circuit and broadcast to the Ncu individual computing circuits of the slave processing circuits. Each of the computing circuits may then perform the element-wise multiplication and accumulation on one input feature line from the first caching circuit and one extended weight data line from the second caching circuit in units of Pci/M=1/Ws data lines to obtain a partial sum of M/Pci=Ws output points.

In other embodiments, the above process of copying and expanding the weight data may also be carried out in a similar manner on a data channel from the second caching circuit to the computing circuits, which is not described in detail herein.

It can be seen that two layers of weights are reused in the above operating process. The first layer is between the computing circuits CUs, since the weights are broadcast to Ncu computing circuits, the number of reusing is Ncu. The second layer is between one or more Wo output points within each computing circuit, and the weights are extended to compute Ws output points within each CU, so the number of reusing is Ws. As a result, by reusing data as much as possible, the frequent access to data and the amount of data access may be effectively reduced.

It is also understood that when the size of the Wo dimension of the output feature map exceeds the amount of data involved in a single computation, for example, Wo>Ws*Ncu, Wo may be cycled according to the slicing of Ws*Ncu.

In some embodiments, output points of an output feature map in a single output channel Co may be computed according to following slicing steps: the output feature map is sliced into (Ws*Ncu)*Ho sized blocks according to the width dimension, and the output points are computed block by block, where Ncu is the number of computing circuits that may be scheduled from the slave processing circuit, and Ho is the size of the height dimension of the output feature map; and for each block, an output circuit is computed in the order of width dimension first, followed by height dimension.

When the slave processing circuit writes an operating result of the computing circuit, an operating result of each computing circuit may be stored in the third caching circuit as shown in FIG. 5 in the order of Wo dimension first and Ho dimension later. When outputting the output points of the computing circuits in the slave processing circuit in the slave processing circuit, the slave processing circuit may output the output points computed by a plurality of computing circuits in a specific sequence according to the division of the output points, which is convenient for subsequent processing. For example, when each slave processing circuit processes convolutional kernels targeting different output channel Co values, it may output an operating result of each computing circuit in turn in the order of a width dimension Wo first, followed by a height dimension Ho. Accordingly, the master processing circuit in the computing apparatus may concatenate and store the operating results output from each slave processing circuit according to a dimensional storage order of HoWoCo according to the order of Co values.

It can also be seen from the previous operating process that Ncu*Ws output points on the Wo dimension of the output feature map are computed each time, in other words, the output points will be aligned to Ncu*Ws, so there may be redundant output points. In a data channel that stores the operating results, the redundant output points on these Wo dimensions may be filtered out.

The following describes the detailed operating process of the convolution operation of the present disclosure in combination with a specific embodiment.

### Embodiment: Ci is Sliced into 2 Segments, and the Number of Sliced Segments Bci is Equal to 2, the Size of Each Segment is 32B, and Co=8

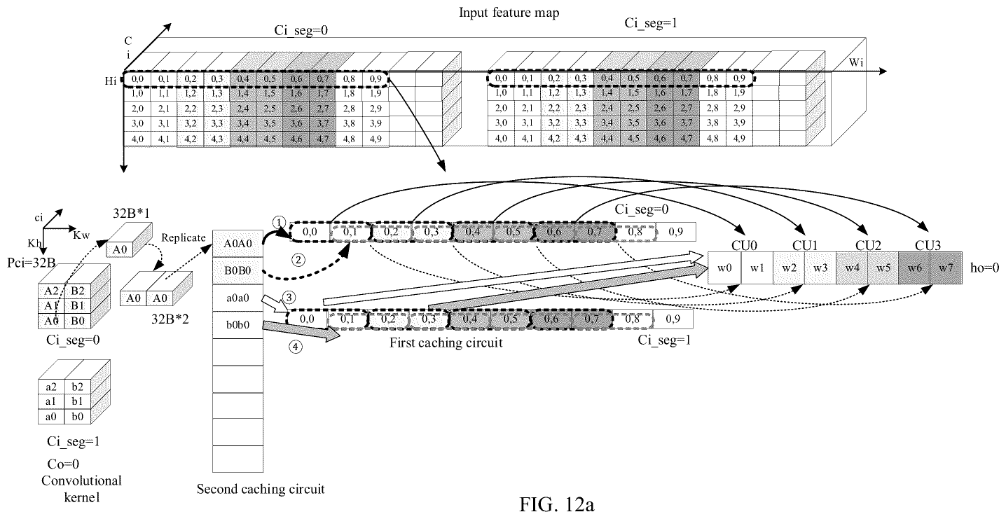

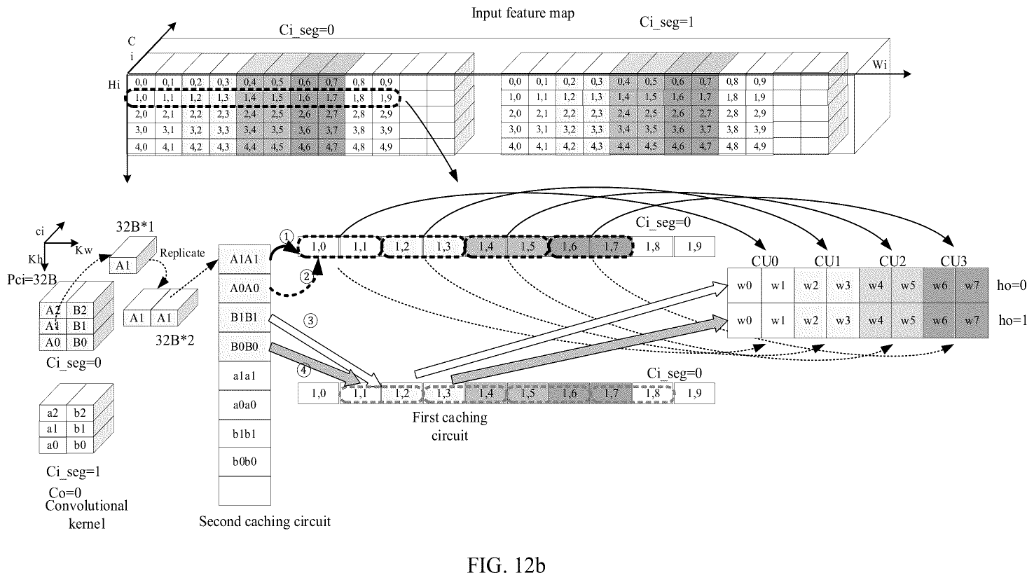

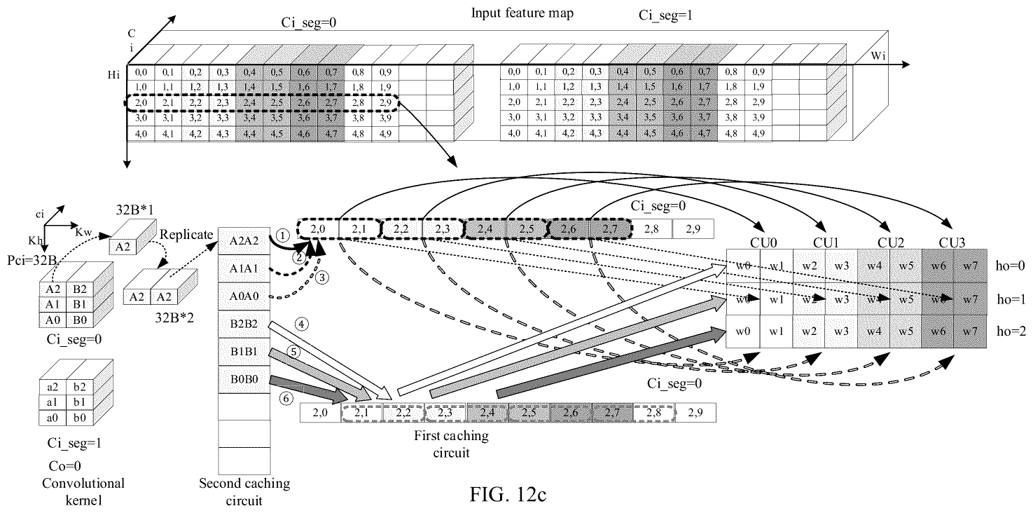

FIG. 12a-FIG. 12c illustrate schematic diagrams of an operating process of the convolution operation scheme according to embodiments of the present disclosure. In this embodiment, Ci is sliced into 2 segments, Ci_seg=0˜1, and the size of each segment is equal to 32B, so a format of one input feature data line is 2×32B (WiCi). The figure shows that each data line consists of 2 columns of Wi data, so that an output block computed by a computing circuit includes of 1×2 (CoWo) output points. Since Co=8, only 8 slave processing circuits may be scheduled, in other words, Ns=8, and each slave processing circuit processes one Co value. It is assumed that the size of a convolutional kernel is KhKw=3×2. In the description below, coordinates <h,w> of the height and width dimensions are used to represent individual data points, the size of each data point in the Ci dimension is Pci, and Pci is equal to 32B in this example.

FIG. 12a illustrates an operating process of, when hi=0, a middle-layer cycle of Ci_seg and an inner-layer cycle of a Kw dimension. According to the manner corresponding to the tiling of the output blocks, Neu input feature lines are selected from the first caching circuit and distributed to Neu computing circuits, and an extended weight data line is selected from the second caching circuit and broadcast to Neu computing circuits for computing.

During a first computation period shown by an arrow \textcircled{1}, numbers are selected from a data segment Ci_seg=0. Specifically, a data line consists of input feature points <0,0> and <0,1> is selected and transmitted to a first computing circuit CU0, a data line consists of input feature points <0,2> and <0,3> is selected and transmitted to a computing circuit CU1, a data line consists of input feature points <0,4> and <0,5> is selected and transmitted to a computing circuit CU2, and a data line consists of input feature points <0,6> and <0,7> is selected and transmitted to a computing circuit CU3 (selected numbers are shown in black dotted boxes). Accordingly, an extended weight line A0A0 extended by a data point <0,0> (hereinafter referred to as “A0”) in a data segment of a convolutional kernel of Ci_seg=0 and broadcast to four computing circuits. Thus, the four computing circuits perform the element-wise multiplication and accumulation respectively to obtain a partial sum of eight output points w0˜w7 on ho, where ho=0, and each computing circuit computes two adjacent output points.

Since data in a data line that hi=0 is not reused in the H dimension, there is no need to reuse data in the H dimension at this time. The inner-layer cycle of the Kw dimension may therefore be continued.

During a second computation period shown by an arrow \textcircled{2}, numbers are still selected from a data segment Ci_seg=0, but sliding is required to be performed in the W dimension. At this point, corresponding 4 input feature lines are selected (selected numbers are shown in slightly smaller gray dotted boxes in the figure) by sliding one stride in the Wi direction from the first caching circuit and transmitted to four computing circuits respectively; and an extended weight line B0B0, which is extended by a data point <0,1> (hereinafter referred to as “B0”), is selected by sliding one stride in the Kw direction from the second caching circuit and broadcast to four computing circuits. Thus, the four computing circuits perform the element-wise multiplication and accumulation respectively. Since the input feature map slides synchronously with the weights, the result is still the partial sum of the eight output points w0˜w7 on ho=0, which is added to the partial sum computed last time.

At this point, the inner-layer cycle of the Kw dimension is complete, in other words, all the partial sums in the Kw direction have been computed. Then, a middle-layer cycle in the Ci_seg dimension is performed. The above number selection and computation process is repeated in the data segment that Ci_seg=1.

During a third computation period shown by an arrow \textcircled{3}, numbers are selected from a convolutional kernel data segment Ci_seg=1 and a data segment of the input feature map, respectively. Specifically, a data line consists of input feature points <0,0> and <0,1> in the data segment of the input feature map of Ci_seg=1 is selected and transmitted to a first computing circuit CU0, a data line consists of input feature points <0,2> and <0,3> is selected and transmitted to a computing circuit CU1, a data line consists of input feature points <0,4> and <0,5> is selected and transmitted to a computing circuit CU2, and a data line consists of input feature points <0,6> and <0,7> is selected and transmitted to a computing circuit CU3 (selected numbers are shown in black dotted boxes). Accordingly, an extended weight line a0a0 extended by a data point <0,0> (hereinafter referred to as “a0”) in a data segment of a convolutional kernel of Ci_seg=1 and broadcast to four computing circuits. Thus, the four computing circuits perform the element-wise multiplication and accumulation respectively. Since the input feature map synchronously select numbers in the Ci dimension with the weights, according to the principle of the convolution operation, the result is still the partial sum of the eight output points w0˜w7 on ho=0, which is added to the partial sum computed last time.

During a fourth computation period shown by an arrow \textcircled{4}, numbers are still selected from a data segment Ci_seg=1, but sliding is required to be performed in the W dimension. At this point, corresponding 4 input feature lines are selected (selected numbers are shown in slightly smaller gray dotted boxes in the figure) by sliding one stride in the Wi direction from the first caching circuit and transmitted to four computing circuits respectively; and an extended weight line b0b0, which is extended by a data point <0,1> (hereinafter referred to as “b0”), is selected by sliding one stride in the Kw direction from the second caching circuit and broadcast to four computing circuits. Thus, the four computing circuits perform the element-wise multiplication and accumulation respectively. Since the input feature map slides synchronously with the weights, the result is still the partial sum of the eight output points w0˜w7 on ho=0, which is added to the partial sum computed last time.

Thus, when hi=0, the middle-layer cycle of Ci_seg and the inner-layer cycle of the Kw dimension are completed.

Then, an outer-layer cycle is performed, in other words, 1 is added to the H dimension.

FIG. 12b shows the cycle processing when hi=1. At this point, the first caching circuit stores data of a data line that hi=1. Similar to FIG. 12a, first, according to the manner corresponding to the tiling of the output blocks, 4 input feature lines are selected from the first caching circuit and distributed to 4 computing circuits, and an extended weight data line is selected from the second caching circuit and broadcast to 4 computing circuits for computing. Different from FIG. 12a, data in the line that hi=1 is reused in the H dimension, in other words, the line of data may be used to compute data points of ho=0 of the output feature map, and may be used to compute data points of ho=1 of the output feature map, in other words, the data may be reused twice.

Specifically, during the first computation period shown by the arrow \textcircled{1}, numbers are selected from the data segment Ci_seg=0. Four data lines shown in the black dotted boxes are selected and transmitted to four computing circuits. At this point, the reuse on the H dimension is applied. In order to compute output points on the H dimension sequentially, the weight data is required to be extracted in reverse order of the H dimension. First, the extended weight line A1A1 extended by the data point <1, 0> (hereinafter referred to as “A1”) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=0, these partial sums add up to the partial sums of the corresponding output points computed earlier.

Then, during the second computation period shown by the arrow \textcircled{2}, the input feature line of each computing circuit is keep unchanged, the extended weight line A0A0 extended by the data point <0,0> (A0) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=1, and each computing circuit computes two adjacent output points.

At this point, the reuse of input feature maps on the H dimension is completed. Then a next cycle in the Kw dimension is performed.

During the third computation period shown by the arrow \textcircled{3}, numbers are still selected from a data segment Ci_seg=0, but 1 stride is slid in the W dimension. At this point, corresponding 4 input feature lines are selected (for clarity, the data in the first caching circuit is repeatedly drawn in the figure, and the selected numbers are shown in slightly smaller gray dashed boxes) by sliding one stride in the Wi direction from the first caching circuit and transmitted to the 4 computing circuits respectively. Similarly, the reuse on the H dimension is inserted. First, the extended weight line BIBI extended by the data point <1,1> (hereinafter referred to as “B1”) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=0, and the partial sum is added up to the results computed earlier.

Then, during the fourth computation period shown by the arrow \textcircled{4}, the input feature line of each computing circuit is keep unchanged, the extended weight line B0B0 extended by the data point <0,1> (B0) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=1, and the partial sum is added up to the results computed earlier.

At this point, the inner-layer cycle of the Kw dimension is complete, in other words, all the partial sums in the Kw direction have been computed. Then, a middle-layer cycle in the Ci_seg dimension is performed. The above number selection and computation process is repeated in the data segment that Ci_seg=1, and the reuse in the H dimension is also embed, which requires a total of 4 computations, which will not be detailed herein. For the sake of simplicity, only the inner-layer cycle process is shown in the figure, and the computation process of the middle-layer cycle may be derived similarly.

Thus, when hi=1, the middle-layer cycle of Ci_seg and the inner-layer cycle of the Kw dimension are completed.

Then, an outer-layer cycle may be continued, in other words, 1 is added to the H dimension, at this point, hi=2.

FIG. 12c shows the cycle processing when hi=2. At this point, the first caching circuit stores data of a data line that hi=2. Similarly, first, according to the manner corresponding to the tiling of the output blocks, 4 input feature lines are selected from the first caching circuit and distributed to 4 computing circuits, and an extended weight data line is selected from the second caching circuit and broadcast to 4 computing circuits for computing. Data in the line that hi=2 is reused in the H dimension, in other words, the line of data may be used to compute data points of ho=0 of the output feature map, and may be used to compute data points of ho=1 of the output feature map, and may be used to compute data points of ho=2 of the output feature map, in other words, the data may be reused three times.

Specifically, during the first computation period shown by the arrow \textcircled{1}, numbers are selected from the data segment Ci_seg=0. Four data lines shown in the black dotted boxes are selected and transmitted to four computing circuits. At this point, the reuse on the H dimension is applied. In order to compute output points on the H dimension sequentially, the weight data is required to be extracted in reverse order of the H dimension. First, the extended weight line A2A2 extended by the data point <2,0> (hereinafter referred to as “A2”) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=0, these partial sums add up to the partial sums of the corresponding output points computed earlier.

Then, during the second computation period shown by the arrow \textcircled{2}, the input feature line of each computing circuit is keep unchanged, the extended weight line A1A1 extended by the data point <1, 0> (A1) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=1, these partial sums add up to the partial sums of the corresponding output points computed earlier.

Then, during the third computation period shown by the arrow \textcircled{3}, the input feature line of each computing circuit is keep unchanged, the extended weight line A0A0 extended by the data point <0,0> (A0) in a data segment of the convolutional kernel of Ci_seg=0 and broadcast to four computing circuits. Thus, the four computing circuits perform the element-wise multiplication and accumulation respectively to obtain a partial sum of eight output points w0˜w7 in a line where ho=2.

At this point, the reuse of input feature map on the H dimension is completed. Then a next cycle in the Kw dimension is performed.

During the fourth computation period shown by the arrow \textcircled{4}, numbers are still selected from the data segment Ci_seg=0, but 1 stride is slid in the W dimension. At this point, corresponding 4 input feature lines are selected (for clarity, the data in the first caching circuit is repeatedly drawn in the figure, and the selected numbers are shown in slightly smaller gray dashed boxes) by sliding one stride in the Wi direction from the first caching circuit and transmitted to the 4 computing circuits respectively. Similarly, the reuse on the H dimension is inserted. First, the extended weight line B2B2 extended by the data point <2,1> (hereinafter referred to as “B2”) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=0, and the partial sum is added up to the results computed earlier.

Then, during a fifth computation period shown by an arrow \textcircled{5}, the input feature line of each computing circuit is keep unchanged, the extended weight line BIBI extended by the data point <1,1> (B1) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=1, and the partial sum is added up to the results computed earlier.

Then, during a sixth computation period shown by the arrow \textcircled{6}, the input feature line of each computing circuit is keep unchanged, the extended weight line B0B0 extended by the data point <0,1> (B0) in a data segment of the convolutional kernel of Ci_seg=0 and broadcast to four computing circuits. Thus, the four computing circuits perform the element-wise multiplication and accumulation respectively to obtain a partial sum of eight output points w0˜w7 on ho, where ho=2, and the partial sum is added up to the results computed earlier.

At this point, the inner-layer cycle of the Kw dimension is complete, in other words, all the partial sums in the Kw direction have been computed. Then, a middle-layer cycle in the Ci_seg dimension is performed. The above selection and computation process is repeated in the data segment that Ci_seg=1, and the reuse in the H dimension is also embed, which requires a total of 6 computations, which will not be detailed herein. For the sake of simplicity, only the inner-layer cycle process is shown in the figure, and the computation process of the middle-layer cycle may be derived similarly.

Thus, when hi=2, the middle-layer cycle of Ci_seg and the inner-layer cycle of the Kw dimension are completed. At this point, values of 8 output points of w0˜w7 on a data line that ho=0 in the output feature map are also accumulated and can be output.

Then, an outer-layer cycle may be continued, in other words, 1 is added to the H dimension, at this point, hi=3. And so on until the entire H dimension has been processed.

When the outer-layer cycle in the H dimension is also completed, each computing circuit may perform an accumulation operation to obtain a final convolution result of ho*Ws 4 output points. Four computing circuits in a slave processing circuit obtain ho* (Ws*4) output points on the same Co. 8 slave processing circuit obtain total ho* (Ws*4) output points on 8 Cos.

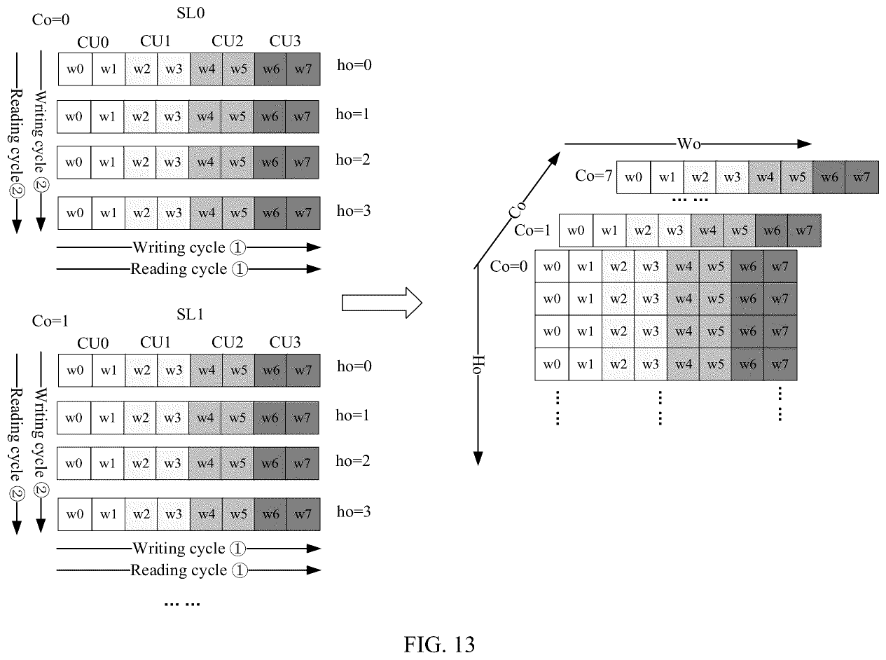

FIG. 13 illustrates a schematic diagram of the logic for writing and outputting an operation result according to an embodiment of the present disclosure.

As shown in the figure, a plurality of computing circuits Cus in a single slave processing circuit SL may write the operating results into a result caching circuit (such as the third caching circuit in FIG. 5) according to the operation order. Specifically, output points of a same Co computed by each CU may be written (a writing cycle \textcircled{1} according to the order of Wo. Then, output points of different Hos computed by each CU may be written (a writing cycle \textcircled{2} according to the order of Ho. For example, w0 to w7 of ho=0 are written first, followed by w0 to w7 of ho=1, then w0 to w7 of ho=2 are written, and so on. Similar result writing is performed in other SLs, but processed Co values are different.

The read order may be the same as the write order, which is also the Wo dimension first, then the Ho dimension. More specifically, firstly, the output points may be read from a result caching circuit of each salve processing circuit in the order of Co, and during the reading process, results of individual Cus are read in the order of Wo. For example, 2 output points w0 and w1 computed by each CU0 in 8 SLs are read first, followed by 2 output points w2 and w3 computed by each CU1, then 2 output points w4 and w5 computed by each CU2 are read, finally, 2 output points w6 and w7 computed by each CU3 are read (a reading cycle \textcircled{1}). Then, output points on each Ho may be read (the reading cycle \textcircled{2}) according to the order of Ho. A right side view in FIG. 13 illustrates a readout result. Please note that when the output points are read in the Co order, the output points are read from result caching circuits of the 8 SLs to make the Co dimension continuous, for example, CO=0˜ CO=7.

The convolutional optimization scheme provided by the present disclosure is described and illustrated by the above specific convolution operation process combined with the embodiments. It will be appreciated that depending on the different values of Ci and Co, there are many more combinations to obtain different embodiments. In addition, based on the teachings of the present disclosure, those skilled in the art may envision other convolutional optimization schemes based on specific hardware circuit configurations (e.g., the number of slave processing circuits, the number of computing circuits within the slave processing circuits, and the one-shot processing capability of the hardware), which fall within the scope of the present disclosure and will not be enumerated herein.

The embodiment of the present disclosure also provides a chip including the data processing apparatus of any embodiment described in conjunction with the drawings. Further, the present disclosure also provides a board card including the above-mentioned chip.

According to different application scenarios, the electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household electrical appliance may include a television, an air conditioner, a microwave oven, a refrigerator, an electric rice cooker, a humidifier, a washing machine, an electric lamp, a gas cooker, and a range hood; and the medical equipment may include a nuclear magnetic resonance spectrometer, a B-ultrasonic scanner, and/or an electrocardiograma electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in the same position or distributed to a plurality of network units. Additionally, according to actual requirements, some or all of the units may be selected to achieve purposes of the solution described in embodiments of the present disclosure. Additionally, in some scenarios, the plurality of units in the embodiments of the present disclosure may be integrated into one unit, or each of the units may be physically separated.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a CPU, a GPU, an FPGA, a DSP, and an ASIC. Further, the aforementioned storage unit or storage apparatus may be any appropriate storage medium (including a magnetic storage medium or a magneto-optical storage medium, and the like), such as an RRAM (resistive random access memory), a DRAM, an SRAM (static random access memory), an EDRAM (enhanced dynamic random access memory), an HBM (high bandwidth memory), an HMC (hybrid memory cube), an ROM (Read-Only Memory), and an RAM, and the like.

The foregoing may be better understood according to following articles:

A1. A computing apparatus, comprising a plurality of slave processing circuits, where each slave processing circuit includes a first caching circuit, a second caching circuit, and a plurality of computing circuits, where
the first caching circuit is used to cache a plurality of input feature lines on which a convolution operation is to be performed, where one of the input feature lines includes the data amount of PcixWs=M in an input feature map, where Pci is a slice granularity of a Ci dimension of an input channel, Ws is a folding multiplier of a W dimension of the width, and M is the amount of data processed by hardware at one time;
the second caching circuit is used to cache weight data on which the convolution operation is to be performed; and
each of the computing circuits is used to perform, at each computation, an element-wise multiplication and accumulation on an input feature line selected from the first caching circuit and an extended weight line selected or generated from the second caching circuit, respectively, where one extended weight line consists of a convolutional kernel sliced in a Ci dimension according to Pci, or consists of a convolutional kernel aligned to a column of data blocks of Pci that is replicated and extended into Ws columns.

A2. The computing apparatus of A1, where each computing circuit is further configured to
reuse the selected input feature line rn times, and perform the element-wise multiplication and accumulation on the reused input feature line with rn extended weight lines corresponding to the convolutional kernel in a height dimension respectively, so as to obtain continuous rn output blocks in the height dimension of an output feature map, wherein rn is determined according to a size Kh of the height dimension of the convolutional kernel and a convolutional stride Sy of the height direction of the convolution operation.

A3. The computing apparatus of A2, further comprising a weight storage circuit configured to store the convolutional kernel, wherein the convolutional kernel is stored in an order from a largest index to a smallest index in the height dimension, so that it is convenient to load the convolutional kernel to the second caching circuit and read the convolutional kernel in an order from a smallest address to a largest address.

A4. The computing apparatus of A2 or A3, where the computing circuits compute a value of a single output point in the output feature map in a following order and through multi-layer cycles, where
a Kw dimension of the convolutional kernel is taken as an inner-layer cycle to compute a partial sum of the output point, and a cycle number Nkw=min (Kw,Kmax), where Kw is a size of the width dimension of the convolutional kernel, and Kmax is a maximum width value of the convolutional kernel supported by the slave processing circuits;
a number Bci of blocks sliced according to Pci in the Ci dimension of the convolutional kernel is taken as a middle-layer cycle to compute a partial sum of the output point, and a cycle number Nci=Bci=ceil (Ci/Pci);
a Kh dimension of the convolutional kernel is taken as an outer-layer cycle to compute a partial sum of the output point, and a cycle number Nkh=Kh, where Kh is a size of the height dimension of the convolutional kernel; and
each partial sum is accumulated to obtain a value of the output point, where the total number of cycles Ncycle=Nkw*Nci*Nkh.

A5. The computing apparatus of A4, where in the inner-layer cycle, each slave processing circuit is further configured to select input feature lines and extended weight lines by sliding synchronously in a width dimension in the first caching circuit and the second caching circuit to compute different partial sums of a same output point, where the number of selections is Nkw.

A6. The computing apparatus of A5, where in each sliding selection computation, each of the computing circuits reuses rn times for a selected input feature line.

A7. The computing apparatus of any one of A2-A6, where each slave processing circuit computes output points of an output feature map in a single output channel Co as follows:
slicing the output feature map into (Ws*Ncu) *Ho sized blocks according to the width dimension, and computing the output points block by block, where Ncu is the number of schedulable computing circuits from the slave processing circuit, and Ho is a size of the height dimension of the output feature map; and
for each block, computing an output circuit in an order of the width dimension first, followed by the height dimension.

A8. The computing apparatus of A7, where for each block, each slave processing circuit computes output points in the weight dimension as follows:
computing Ncu continuous output blocks in parallel in the width dimension of the output feature map by using the schedulable Neu computing circuits, where each output block includes Ws continuous output points in the width dimension.

A9. The computing apparatus of A8, wherein each slave processing circuit is further configured to
select adjacent Neu input feature lines from the first caching circuit and distribute the selected Ncu input feature lines to Neu computing circuits for computing;
select or generate a corresponding extended weight line from the second caching circuit and broadcast the extended weight line to Neu computing circuits; and
perform the element-wise multiplication and accumulation, at the Ncu computing circuits, on the distributed input feature lines and broadcast extended weight line in units of 1/Ws data lines to obtain a partial sum of Ws output points.

A10. The computing apparatus of any one of A7-A9, where for each block, each slave processing circuit computes output points in the height dimension as follows:
at each computing unit, by reusing rn input feature lines, successively computing a partial sum of continuous rn output blocks in the height dimension of the output feature map, where each output block includes Ws continuous output points in the width dimension.

A11. The computing apparatus of any one of A1-A10, where
each slave processing circuit processes convolutional kernels for different output channels Co, and outputs an operating result of each computing circuit in turn in an order of a width dimension Wo first, followed by a height dimension Ho; and
the computing apparatus is further configured to, in the order of co values, concatenate and store operating results output from each slave processing circuit in a dimensional storage order of HoWoCo.

A12. A chip, comprising the computing apparatus of any one of A1-A11.

A13. A board card, comprising the chip of A12.

A14. A method using the computing apparatus of any one of A1-A11 to perform a convolution operation.

The embodiments of the present disclosure have been described in detail above. Specific embodiments have been used in the specification to explain the principles and implementation manners of the present disclosure. The descriptions of the above embodiments are only used to facilitate understanding of the methods and core ideas of the present disclosure. Persons of ordinary skill in the art may change the implementation and application scope according to the ideas of the present application. In summary, the content of this specification should not be construed as a limitation on the present disclosure.

1. A computing apparatus, comprising a plurality of slave processing circuits, wherein each slave processing circuit includes a first caching circuit, a second caching circuit, and a plurality of computing circuits, wherein
the first caching circuit is used to cache a plurality of input feature lines on which a convolution operation is to be performed, wherein one of the input feature lines includes the data amount of Pci×Ws=M in an input feature map, where Pci is a slice granularity of a Ci dimension of an input channel, Ws is a folding multiplier of a W dimension of the width, and M is the amount of data processed by hardware at one time;
the second caching circuit is used to cache weight data on which the convolution operation is to be performed; and
each of the computing circuits is used to perform, at each computation, an element-wise multiplication and accumulation on an input feature line selected from the first caching circuit and an extended weight line selected or generated from the second caching circuit, respectively, wherein the extended weight line consists of a convolutional kernel sliced in a Ci dimension according to Pci, or consists of a convolutional kernel aligned to a column of data blocks of Pci that is replicated and extended into Ws columns.

2. The computing apparatus of claim 1, wherein each computing circuit is further configured to:
reuse the selected input feature line rn times, and perform the element-wise multiplication and accumulation on the reused input feature line with rn extended weight lines corresponding to the convolutional kernel in a height dimension respectively, so as to obtain continuous rn output blocks in the height dimension of an output feature map, wherein rn is determined according to a size Kh of the height dimension of the convolutional kernel and a convolutional stride Sy of the height direction of the convolution operation.

3. The computing apparatus of claim 2, further comprising a weight storage circuit configured to store the convolutional kernel, wherein the convolutional kernel is stored in an order from a largest index to a smallest index in the height dimension, so that it is convenient to load the convolutional kernel to the second caching circuit and read the convolutional kernel in an order from a smallest address to a largest address.

4. The computing apparatus of claim 2, wherein the computing circuits compute a value of a single output point in the output feature map in a following order and through multi-layer cycles, wherein
a Kw dimension of the convolutional kernel is taken as an inner-layer cycle to compute a partial sum of the output point, and a cycle number Nkw=min (Kw,Kmax), wherein Kw is a size of the width dimension of the convolutional kernel, and Kmax is a maximum width value of the convolutional kernel supported by the slave processing circuits;
a number of blocks Bci sliced according to Pci in the Ci dimension of the convolutional kernel is taken as a middle-layer cycle to compute a partial sum of the output point, and a cycle number Nci=Bci=ceil (Ci/Pci);
a Kh dimension of the convolutional kernel is taken as an outer-layer cycle to compute a partial sum of the output point, and a cycle number Nkh=Kh, wherein Kh is a size of the height dimension of the convolutional kernel; and
each partial sum is accumulated to obtain a value of the output point, wherein the total number of cycles Ncycle=Nkw*Nci*Nkh.

5. The computing apparatus of claim 4, wherein in the inner-layer cycle, each slave processing circuit is further configured to select input feature lines and extended weight lines by sliding synchronously in a width dimension in the first caching circuit and the second caching circuit to compute different partial sums of a same output point, where the number of selections is Nkw.

6. The computing apparatus of claim 5, wherein in each sliding selection computation, each of the computing circuits reuses rn times for a selected input feature line.

7. The computing apparatus of claim 2, wherein each slave processing circuit computes output points of an output feature map in a single output channel Co as follows:
slicing the output feature map into (Ws*Ncu) *Ho sized blocks according to the width dimension, and computing the output points block by block, wherein Ncu is the number of schedulable computing circuits from the slave processing circuit, and Ho is a size of the height dimension of the output feature map; and
for each block, computing an output circuit in an order of the width dimension first, followed by the height dimension.

8. The computing apparatus of claim 7, wherein for each block, each slave processing circuit computes output points in the weight dimension as follows:
computing Ncu continuous output blocks in parallel in the width dimension of the output feature map by using the schedulable Ncu computing circuits, wherein each output block includes Ws continuous output points in the width dimension.

9. The computing apparatus of claim 8, wherein each computing circuit is further configured to:
select adjacent Ncu input feature lines from the first caching circuit and distribute the selected Ncu input feature lines to Ncu computing circuits for computing;
select or generate a corresponding extended weight line from the second caching circuit and broadcast the extended weight line to Ncu computing circuits; and
perform the element-wise multiplication and accumulation, at the Ncu computing circuits, on the distributed input feature lines and broadcast extended weight line in units of 1/Ws data lines to obtain a partial sum of Ws output points.

10. The computing apparatus of claim 7, wherein for each block, each slave processing circuit computes output points in the height dimension as follows:
at each computing unit, by reusing rn input feature lines, successively computing a partial sum of continuous rn output blocks in the height dimension of the output feature map, wherein each output block includes Ws continuous output points in the width dimension.

11. The computing apparatus of claim 1, wherein
each slave processing circuit processes convolutional kernels for different output channels Co, and outputs an operating result of each computing circuit in turn in an order of a width dimension Wo first, followed by a height dimension Ho; and
the computing apparatus is further configured to, in the order of co values, concatenate and store operating results output from each slave processing circuit in a dimensional storage order of HoWoCo.

12. A chip, comprising a computing apparatus, wherein the computing apparatus comprises a plurality of slave processing circuits, wherein each slave processing circuit includes a first caching circuit, a second caching circuit, and a plurality of computing circuits, wherein
the first caching circuit is used to cache a plurality of input feature lines on which a convolution operation is to be performed, wherein one of the input feature lines includes the data amount of PcixWs=M in an input feature map, where Pci is a slice granularity of a Ci dimension of an input channel, Ws is a folding multiplier of a W dimension of the width, and M is the amount of data processed by hardware at one time;
the second caching circuit is used to cache weight data on which the convolution operation is to be performed; and
each of the computing circuits is used to perform, at each computation, an element-wise multiplication and accumulation on an input feature line selected from the first caching circuit and an extended weight line selected or generated from the second caching circuit, respectively, wherein the extended weight line consists of a convolutional kernel sliced in a Ci dimension according to Pci, or consists of a convolutional kernel aligned to a column of data blocks of Pci that is replicated and extended into Ws columns.

13. (canceled)

14. A method for using a computing apparatus of to perform a convolution operation, wherein the computing apparatus comprises a plurality of slave processing circuits, wherein each slave processing circuit includes a first caching circuit, a second caching circuit, and a plurality of computing circuits, wherein the first caching circuit is used to cache a plurality of input feature lines on which a convolution operation is to be performed, wherein one of the input feature lines includes the data amount of Pci×Ws=M in an input feature map, where Pci is a slice granularity of a Ci dimension of an input channel, Ws is a folding multiplier of a W dimension of the width, and M is the amount of data processed by hardware at one time;
the second caching circuit is used to cache weight data on which the convolution operation is to be performed; and
each of the computing circuits is used to perform, at each computation, an element-wise multiplication and accumulation on an input feature line selected from the first caching circuit and an extended weight line selected or generated from the second caching circuit, respectively, wherein the extended weight line consists of a convolutional kernel sliced in a Ci dimension according to Pci, or consists of a convolutional kernel aligned to a column of data blocks of Pci that is replicated and extended into Ws columns.

15. The computing apparatus of claim 3, wherein the computing circuits compute a value of a single output point in the output feature map by performing the following and through multi-layer cycles:
taking a Kw dimension of the convolutional kernel as an inner-layer cycle to compute a partial sum of the output point, and a cycle number Nkw=min (Kw,Kmax), wherein Kw is a size of the width dimension of the convolutional kernel, and Kmax is a maximum width value of the convolutional kernel supported by the slave processing circuits;
taking a number of blocks Bci sliced according to Pci in the Ci dimension of the convolutional kernel as a middle-layer cycle to compute a partial sum of the output point, and a cycle number Nci=Bci=ceil (Ci/Pci);
taking a Kh dimension of the convolutional kernel as an outer-layer cycle to compute a partial sum of the output point, and a cycle number Nkh=Kh, wherein Kh is a size of the height dimension of the convolutional kernel; and
accumulating each partial sum to obtain a value of the output point, wherein the total number of cycles Ncycle=Nkw*Nci*Nkh.

16. The computing apparatus of claim 3, wherein each slave processing circuit computes output points of an output feature map in a single output channel Co by:
slicing the output feature map into (Ws*Ncu) *Ho sized blocks according to the width dimension, and computing the output points block by block, wherein Ncu is the number of schedulable computing circuits from the slave processing circuit, and Ho is a size of the height dimension of the output feature map; and
for each block, computing an output circuit in an order of the width dimension first, followed by the height dimension.

17. The computing apparatus of claim 4, wherein each slave processing circuit computes output points of an output feature map in a single output channel Co by:
slicing the output feature map into (Ws*Ncu) *Ho sized blocks according to the width dimension, and computing the output points block by block, wherein Ncu is the number of schedulable computing circuits from the slave processing circuit, and Ho is a size of the height dimension of the output feature map; and
for each block, computing an output circuit in an order of the width dimension first, followed by the height dimension.

18. The computing apparatus of claim 5, wherein each slave processing circuit computes output points of an output feature map in a single output channel Co by:
slicing the output feature map into (Ws*Ncu) *Ho sized blocks according to the width dimension, and computing the output points block by block, wherein Ncu is the number of schedulable computing circuits from the slave processing circuit, and Ho is a size of the height dimension of the output feature map; and
for each block, computing an output circuit in an order of the width dimension first, followed by the height dimension.

19. The computing apparatus of claim 6, wherein each slave processing circuit computes output points of an output feature map in a single output channel Co by:
slicing the output feature map into (Ws*Ncu) *Ho sized blocks according to the width dimension, and computing the output points block by block, wherein Ncu is the number of schedulable computing circuits from the slave processing circuit, and Ho is a size of the height dimension of the output feature map; and
for each block, computing an output circuit in an order of the width dimension first, followed by the height dimension.

20. The computing apparatus of claim 8, wherein for each block, each slave processing circuit computes output points in the height dimension by:
at each computing unit, by reusing rn input feature lines, successively computing a partial sum of continuous rn output blocks in the height dimension of the output feature map, wherein each output block includes Ws continuous output points in the width dimension.

21. The computing apparatus of claim 9, wherein for each block, each slave processing circuit computes output points in the height dimension by:
at each computing unit, by reusing rn input feature lines, successively computing a partial sum of continuous rn output blocks in the height dimension of the output feature map, wherein each output block includes Ws continuous output points in the width dimension.
